(19) United States
(12) Patent Application Publication
(10) Pub. No.: US 2025/0132991 A1
(43) Pub. Date: Apr. 24, 2025

(54) Method and Apparatus for Determining and Responding to Nonconformance with Service Level Agreements by a Production Domain

(71) Applicants: Telefonaktiebolaget LM Ericsson (publ), Stockholm (SE); ERICSSON TELEKOMMUNIKATION GMBH, Frankfurt (DE)

(72) Inventors: Elisabeth Mueller, Mainz (DE); Bernd Hertel, Seeheim-Jugenheim, Hessen (DE); Rohit Singhal, Delhi (IN); Ajit Raghavan, New Delhi (IN); Peter Cyril, Mississauga (CA); Plamen Stanoev, Oakville (CA)

(21) Appl. No.: 18/570,277

(22) PCT Filed: Nov. 10, 2021
(86) PCT No.: PCT/SE2021/051124

§ 371 Date: Dec. 14, 2023

(30) Foreign Application Priority Data
Jun. 22, 2021 (IN) 202141027933

(51) Int. Cl. H04L 41/50; H04L 41/5019

(52) U.S. Cl. CPC H04L 41/5029; H04L 41/5019

(57) ABSTRACT

Disclosed techniques include evaluating Key Performance Indicator (KPI) event information from a production domain (16) to identify nonconformance of a service provided via the production domain with a Service Level Agreement (SLA) governing the service, and outputting actionable nonconformance information. Among the several advantages gained via the disclosed techniques is the use of even low-level KPIs over time to determine higher-level compliance or non-compliance with Service Level Objectives (SLOs) defined by the SLA and the ability to drive Business Support Systems (BSSs) or Service Assurance Systems (SASs) via nonconformance information determined from identified nonconformance with the SLA.

### TECHNICAL FIELD

Aspects of this disclosure relate to detecting nonconformance of a provided service with a Service Level Agreement (SLA) and providing corresponding nonconformance information, e.g., for control purposes.

### BACKGROUND

Capabilities associated with Fifth Generation (5G) networks introduce multiple new opportunities for Communication Service Providers (CSPs) to monetize on connectivity services, tailored towards the exact needs of enterprise customers originating from use cases far beyond more traditional telecommunications. Providing tailored connectivity involves, for example, configuring, creating and life-cycle managing network (NW) slices and services provided via NW slices, which are then sold to enterprise customers of a CSP. The services can be provided by single service providers or can be hybrid services realized on multiple platforms working together.

CSPs need to agree with their customers on the service level and quality that will be delivered by a service running on a NW slice. These customers may be enterprise customers or consumers and in a broad sense may be referred to as “subscribers”. Further agreement may be needed regarding the consequences, in case the service quality criteria are not fulfilled. These agreements, referred to as “Service Level Agreements,” may be legally binding. Consequently, monitoring the realized service quality for such services would have value both to the service providers and their customers.

Service providers often run Service Assurance Systems (SASs) to monitor the various network functions used to realize or otherwise provide services via their networks or other types of production domains, and to trigger actions to keep the involved production domains in a stable and performant state. Here, a “production domain” is a telecommunication network, a data-processing or data-storage center or any other electronic system operative to provide one or more types of services to customers, and, particularly, to provide services governed by SLAs.

As of today, there exist certain, limited SLA management functions to capture the agreements between a service provider and its customers. However, these functions are completely independent of service assurance and a number of unmet challenges complicate their use and limit their value.

First, as noted, existing SLA management approaches are decoupled from service assurance. There is no SLA management function available that can use insights on service behavior from one or more SASs. The “closed loop service assurance” known today exclusively addresses the feedback loop between service orchestration and service assurance, with no connection to management of SLAs between a service provider and a customer.

A further problem flows from the increasing tendency of customers to focus on “Quality of Experience” or “QoE,” which is expressed by Key Quality Indicators (KQIs). Such KQIs depend on underlying measurements of specific aspects of the performance of the production domain with respect to providing the service in question. Performance measurements expressible in terms of Key Performance Indicators (KPIs) generally are low-level technical metrics that may or may not have a clear relationship to the service-quality requirements defined by a SLA.

Certain known approaches offer examples of formulating KQIs having more relevance to overarching quality requirements. See the patent CN102546220B, for example.

However, existing approaches offer no solution relating such measurements or calculated values to SLAs, much less using such measurements or values to determine the extent of conformance or nonconformance of a provided service with the SLA governing it. Beyond the absence of existing solutions for determining SLA compliance or noncompliance using, for example, lower-level performance data from the production domain in question, known solutions do not provide mechanisms for automated determination of SLA compliance or conformance, with a corresponding feeding back of such information, or information derived from such information to one or more SASs associated with the production domain.

### SUMMARY

Disclosed techniques include evaluating Key Performance Indicator (KPI) event information from a production domain to identify nonconformance of a service provided via the production domain with a Service Level Agreement governing the service, and outputting actionable nonconformance information. Among the several advantages gained by use of the disclosed techniques is the use of even low-level KPIs over time to determine higher-level compliance or non-compliance with Service Level Objectives (SLOs) defined by the SLA and the ability to drive Business Support Systems (BSSs) or Service Assurance Systems (SASs) via the nonconformance information.

A method according to one embodiment is performed by a computer system associated with a production domain. The method includes receiving KPI event information that is related to a service that is provided by the production domain and governed by a SLA, evaluating the KPI event information corresponding to a compliance period defined for the SLA, to detect nonconformance of the provided service with the SLA, generating nonconformance information according to detected nonconformance, and outputting the nonconformance information to one or more business or control systems associated with the production domain.

In another embodiment, a method performed by a computer system associated with a production domain includes determining which KPI events are related to conforming with a SLA, from among a plurality of KPI events corresponding to a defined monitoring interval, e.g., a compliance period defined for the SLA. The method further includes identifying instances of performance-requirement violations, according to the related KPI events, and determining whether in aggregation the identified instances of performance-requirement violations constitute a quality-requirement violation, with respect to one or more quality requirements defined by the SLA, and, if so, outputting conformance information indicating the quality-requirement violation.

A method according to another embodiment is performed by a computer system associated with a production domain and includes receiving items of performance data comprising KPI events for one or more types of measured performance of a production domain. With respect to a SLA governing a corresponding service provided by the production domain, the method includes calculating values for one or more Key Quality Indicators (KQIs) with respect to a compliance period defined for the SLA, based on related items of performance data from among the received items of performance data. Further, the method includes identifying nonconformance of the provided service with the SLA for the compliance period, based on evaluating the calculated values of the one or more KQIs with respect to corresponding quality targets defined by SLOs of the SLA, generating nonconformance information according to any identified nonconformance, outputting the nonconformance information to one or more business control systems associated with the production domain.

A computer system according to one embodiment is associated with a production domain and includes communication interface circuitry and processing circuitry operatively associated with the communication interface circuitry. The processing circuitry is configured to receive, via the communication interface circuitry, items of performance data comprising KPI events for one or more types of measured performance of a production domain. With respect to a SLA governing a corresponding service provided by the production domain, the processing circuitry is configured to: calculate values for one or more KQIs with respect to a compliance period defined for the SLA, based on related items of performance data from among the received items of performance data; identify nonconformance of the provided service with the SLA for the compliance period, based on evaluating the calculated values of the one or more KQIs with respect to corresponding quality targets defined by SLOs of the SLA; generate nonconformance information according to any identified nonconformance; and output the nonconformance information to one or more business control systems associated with the production domain.

A method according to another embodiment is performed by a computer system and includes receiving items of performance data comprising KPI events for one or more types of measured performance of a production domain. The method further includes correlating one or more identifiers associated with the items of performance data with SLA information, to identify items of performance data relating to services provided by the production domain SLAs, where each such SLA is considered to be an affected SLA with respect to such related items of performance data. Correspondingly, for each affected SLA, the method includes: calculating values for one or more KQIs for a defined monitoring period, using the related items of performance data corresponding to the defined monitoring period; identifying nonconformance with the affected SLA for the defined monitoring period, based on evaluating the calculated values of the one or more KQIs with respect to corresponding quality targets defined by SLOs of the SLA; generating nonconformance information according to the identified nonconformance; and outputting the nonconformance information to one or more business or control systems associated with the production domain.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment and illustrates a computer system operative as a Service Level Agreement (SLA) management entity, also referred to as a SLA manager.

FIG. 2 is a block diagram illustrating example functional or logical processing blocks of a SLA manager.

FIG. 3 is a block diagram of further example details for a SLA manager, according to one embodiment.

FIGS. 4-6 are logic flow diagrams of methods performed by a computer system, according to example embodiments.

FIG. 7 is a block diagram of example implementation details for a computer system operative as a SLA manager.

FIGS. 8 and 9 are block diagrams of further example implementation details for a computer system operative as a SLA manager.

FIG. 10 is a block diagram of a wireless communication network according to an example embodiment.

FIG. 11 is a block diagram of a SLA manager according to one embodiment.

FIG. 12 is a logic flow diagram of one embodiment of a method of SLA management.

FIG. 13 is a block diagram of SLA management according to an example embodiment involving network slices.

FIGS. 14-17 are logic flow diagrams of SLA management method according to example embodiments.

FIG. 18 is a block diagram of example SLA nonconformance information comprising nonconformance consequences, according to an example embodiment.

FIG. QQ1 is a block diagram of an example wireless network, according to one embodiment.

FIG. QQ2 is a block diagram of an example User Equipment (UE), according to one embodiment.

FIG. QQ3 is a block diagram of an example network node, according to one embodiment.

FIG. QQ4 is a block diagram of an example host computer, according to one embodiment.

FIG. QQ5 is a block diagram of an example virtualization environment, according to one embodiment.

FIG. QQ6 is a logic flow diagram illustrating a method implemented in a communication system, according to an example embodiment.

### DETAILED DESCRIPTION

Certain aspects of the present disclosure and the disclosed embodiments may provide solutions to the challenges noted above, or to other challenges. A solution according to one embodiment disclosed herein introduces a Service Level Agreement (SLA) management function that is integrated with or otherwise communicatively coupled to one or more Service Assurance Systems (SASs) that orchestrate or otherwise influence resource-allocation prioritizations within a production environment. According to an example implementation, the SLA management function, also referred to as a “SLA manager”, uses the insights on service production collected by the SAS(s), to determine the compliance or violation level of the objectives defined in a SLA associated with the produced service, which also may be referred to as the provided service.

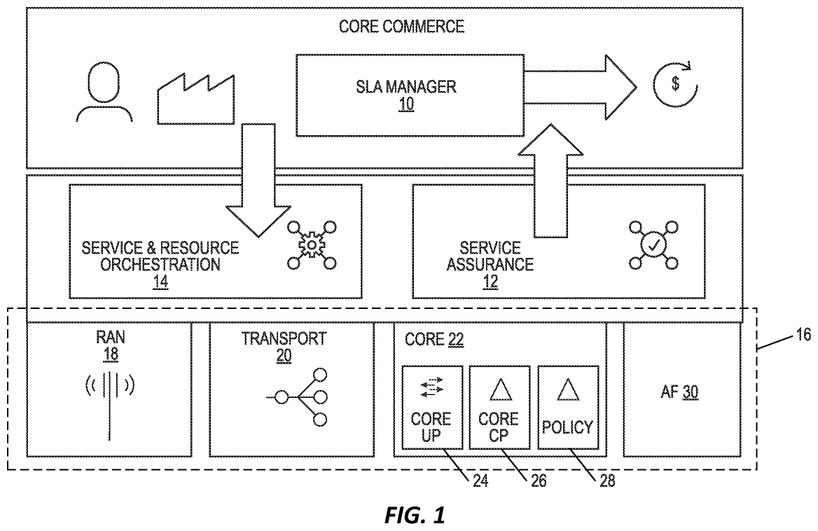

FIG. 1 illustrates a SLA manager 10 according to an example embodiment. Service assurance insights, e.g., Key Performance Indicator (KPI) event information, are provided to the SLA manager 10 by the SAS(s) 12 and are used by the SLA manager 10 to calculate the degree of compliance to service objectives. The “consequences” of detected noncompliance, also referred to as nonconformance, are determined and fed back to a Service and Resource Orchestration function 14, thereby enabling optimization of service-scaling actions across various services that compete for resources in the production domain 16 at issue.

Various integration patterns between service assurance and SLA management are supported by the various embodiments disclosed herein. Among such support is the ability of a SLA manager 10 to receive and process event information indicating violation and clearance incidents for one or more defined KPIs. Additionally, or alternatively, one or more SASs 12 provide the SLA manager 10 with event information indicating continuous measurements, e.g., measured values of throughput, packet loss, etc., such as may be measured on a recurring basis within the production environment during service production—i.e., while providing a service—and reported to the SLA manager 10.

The functions subject to service assurance can reside in production domains 16 owned by a CSP or other types of service providers. Example production domains include communication networks, data storage networks, cloud-processing networks, and the like. FIG. 1 illustrates an example situation in which the production domain 16 is a communication network that includes a Radio Access Network (RAN) 18, a transport network 20 coupling the RAN 18 to a Core Network (CN) 22 that includes User Plane (UP) functions 24 and Control Plane (CP) functions 26, along with policy control and enforcement functions 28. One or more Application Functions (AFs) 30 are included in or associated with the production domain 16, e.g., for providing services such as data services.

As noted, a function provided by the SLA manager 10 in one or more embodiments is the calculation of compliance or violation of the Service Level Objectives (SLOs) defined in a Service Level Agreement (SLA) between an operator or owner of a production domain 16 and a customer that uses a service provided by or through the production domain. That is, the production domain produces a service consumed or used by a customer, with the production governed by a SLA that defines one or more SLOs for production of the service. Here, the phrase “producing a service” may be understood as meaning, or at least encompassing, providing the service.

As a non-limiting example, a telecommunication network serves as an access network-a communication link-between a user and a data-service provider. In this scenario, a SLA may govern the performance of the telecommunication network as the production domain 16 in question, and the customer in question may be a user of a service that is provided by the telecommunication network according to a SLA agreed between the customer and the operator of the telecommunication network or the data-service provider, or both. Additionally, or alternatively, the data-service provider may pay for use of the telecommunication network and may have a SLA in place with the network operator regarding guaranteed performance of the network with respect to the data-service provider's usage.

In at least one embodiment, a technique used to realize a SLA management solution includes a number of aspects or operations, including the following aspects or operations.
1. Lifecycle management of SLAs for single domain and hybrid domain services integrated to external Catalog Management and Customer Relationship Management (CRM) systems.
2. Real-time monitoring of service quality objectives by integrating with multiple service assurance functions.
3. Ability to consider events from multiple service assurance systems from different production domains.
4. Detection of service degradation, violating the agreed quality of service and consequence determination.
5. Triggering application of consequences for nonconformance with SLA requirements.
6. Feedback of consequences to service and resource management, to influence orchestration of NW functions.

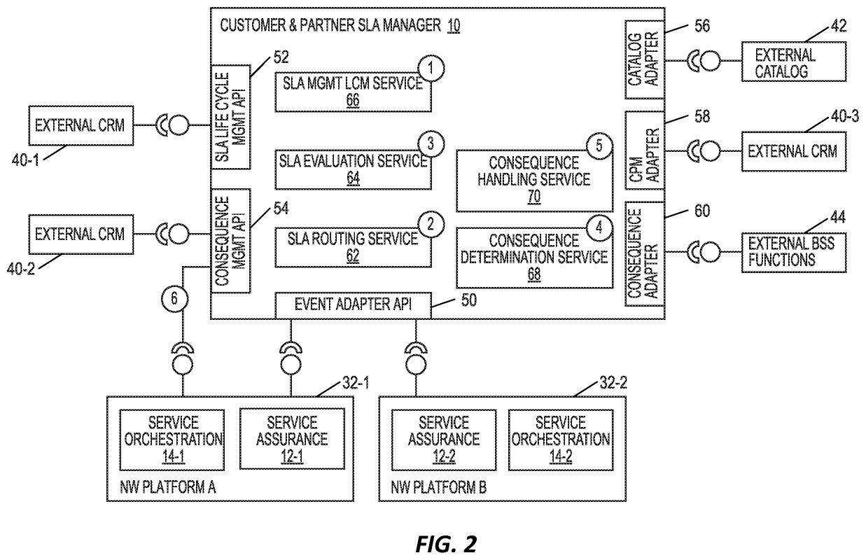

A depiction of a SLA manager 10 according to an example embodiment appears in FIG. 2. Here, the SLA manager 10 interfaces with one or more network (NW) platforms, shown by way of example as NW platforms 32-1 and 32-2. The network platform 32-1 includes a SAS 12-1 and a Service Orchestration function 14-1, and the network platform 32-2 includes a SAS 12-2 and a Service Orchestration function 14-2.

The SLA manager 10 also interfaces with one or more Customer Relationship Management (CRM) systems 40, shown by way of example as CRMs 40-1, 40-2, and 40-3, which may be associated with the network platforms 32-1 and 32-2. The SLA manager 10 may also interface with or use an external catalog 42 and one or more external Business Support System (BSS) functions 44.

An event adapter Application Programming Interface (API) 50 provides a mechanism for receiving items of performance data from the SASs 12, e.g., KPI event information, while a SLA life cycle management API 52 provides a mechanism for the SLA manager 10 to obtain SLA information defining one or more SLAs. A consequence management API 54 provides a mechanism for the SLA manager 10 to receive configuration information defining consequences for nonconformance with SLAs.

A catalog adaptor 56 provides a mechanism for interfacing the SLA manager 10 with the external catalog 42. Among other things, the mechanism supports retrieval of Service specifications, Resource specifications, and Service Level specification assets, including aggregation and transformation rules of KPIs into KQIs. A CPM adaptor 58 provides a mechanism for interfacing the SLA manager 10 with the external CRM 40-3 used to retrieve details on customers, their contracts and agreements, their product and service history. A consequence adaptor 60 provides a mechanism for outputting consequence data, as an example of nonconformance information generated by the SLA manager 10 in response to detecting nonconformance with a SLA. The SLA manager 10 may be structured according to functions or sets of functions used in SLA management, and in the illustrated embodiment includes a SLA routing service 62 to relate incoming performance data to SLAs, a SLA evaluation service 64 that is configured to translate or otherwise process the performance data for tracking compliance with SLA requirements—e.g., compliance with KQI targets. Additional services or functional entities include a SLA management LCM service 66, a consequence determination service 68, and a consequence handling service 70, to determine and trigger consequences for nonconformance with a SLA.

The SLA manager 10 in one or more embodiments combines information on performance indicators determined by one or more service assurance systems to calculate key quality indicators (KQIs).

Example KPIs include:
avrgDelayE2EUL, depicting the average e2e UL packet delay between the gateway and the device (where “e2e” denotes end-to-end),
avrgULThroughput, depicting the average uplink throughput for a device
avrgDLThroughput, depicting the average downlink throughput for a device
PDUsessionSuccessRate, indicating the ratio of successfully established PDU sessions versus attempts.
RegistrationSuccessRate, indicating the ratio of successfully performed registrations of devices to the mobile network versus attempts.

Example KQIs calculated from KPIs are:
DLthroughput
ULquality, calculated as a weighted number out of avrgDelayE2EUL meeting a certain threshold target, e.g. avrgDelayE2EUL<=30 ms and in parallel avrgULThroughput meeting another threshold target, e.g. avrgULThroughput>=10 Mbit/s, e.g. ULquality=0.4*(30 ms/avrgDelayE2EUL)+0.6*(avrgULThroughput/10 Mbit/s)
AccessibilityRate, calculated as (PDUsessionSuccessRate+RegistrationSuccessRate)/2

Amongst other settings an SLA specifies a commercial monitoring periods and a list of service level objectives (SLOs), which define targets for KQIs to be achieved during the monitoring period and consequences if these targets cannot be met.

To calculate the SLO status, the periods of violation of the KQI targets are determined and related to the commercial monitoring period as agreed in the SLA. This leads to the determination of commercial consequences in case of violations. The commercial monitoring period may also be referred to as a compliance period or defined monitoring period, and it may correspond with a defined billing cycle, such as a month. Different SLAs may have the same compliance period in terms of duration or beginning and end dates/times, or different SLAs may have different compliance periods. An example compliance period is a month.

SLA management in at least one embodiment is integrated to external CRM functions, which provide management operations with respect to a customer having a SLA in place with the operator of the production domain. The SLA manager may integrate with or be communicatively coupled with systems having information identifying installed bases of products and services bought by respective customers and also the specification catalog responsible for providing the service specifications and the service level specifications. Via an event adapter, the SLA manager is integrated to one or many SASs. Via a consequence adapter, the SLA manager is integrated with an external CRM system. More generally, the SLA manager may be integrated with one or more business or control systems, and may output nonconformance information to such systems, regarding detected nonconformance with one or more SLAs.

Certain embodiments may provide one or more of the following technical advantage(s):
1. A solution where events data (e.g., containing information about Key Performance Indicators (KPIs)) from service assurance system(s) or customer experience assurance systems are correlated to customer-understandable KQIs, to ascertain conformance or nonconformance of service production with the SLA automatically and accurately.
   a. KPI To KQI correlation is done in real-time which can be responded in real-time and address any elongated detrimental effects
   b. There is a flexibility to also integrate batch events data of KPIs
   c. Flexibility of integrating various Service assurance or Customer experience assurance systems
   d. The customer SLA compliance management is extremely important in 5G to gain customer confidence in compliance of service quality of contracted services and to explain the service quality compliance levels based on drill down to service or network performance data, if so required
   e. A customer SLA violation leads to a consequence which most often results in service credits or payout, a less accurate method will lead to revenue leakage
2. A solution where consequences are determined automatically based on customer SLA compliance level achieved.
3. A solution where actuation of consequences in target systems is done automatically or with manual intervention of a supervisor.
4. Feedback of consequences to service resource management and orchestration function is critical input to allow for adjusting and optimizing service orchestration actions automatically, to better distribute resources between competing services. In case of customer SLA violation, such feedback loop helps in safeguarding against subsequent violations.

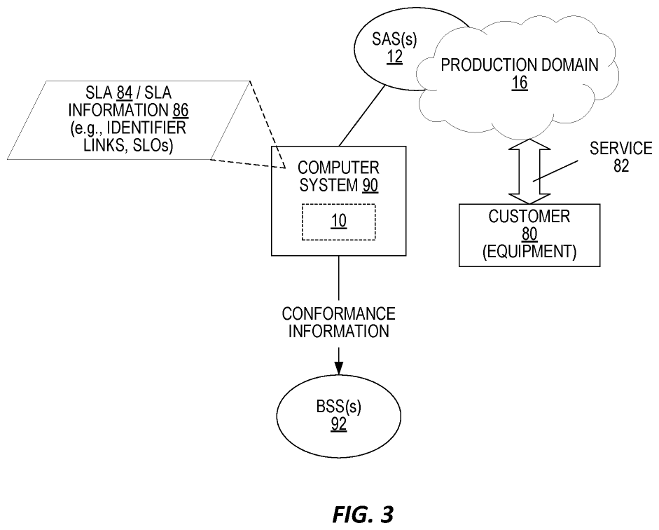

FIG. 3 depicts a customer 80—e.g., one or more items of customer equipment or customer systems—that use a service 82 that is provided via a production domain 16 according to a SLA 84. The SLA 84 includes or is at least partially represented by SLA information 86, such as user/equipment identifiers, service identifiers, Service Level Objectives (SLOs) that define targets for Key Quality Indicators (KQIs), etc.

A computer system 90 is configured as a SLA manager 10 according to an example embodiment. The computer system 90 is associated with the production domain 16—e.g., included in the production domain 16 or operatively associated with it. One or more SAS(s) 12 provide items of performance data—KPI event information—to the computer system 90 and the computer system 90 uses such information to determine conformance or nonconformance with the SLA 84. As explained, the SLA 84 governs the service 82 provided by the production domain 16 to the customer 80. The computer system 90 generates conformance information that indicates identified nonconformance and provides the conformance information to one or more Business Support Systems, shown as BSS(s) 92 in the diagram, or to the SAS(s) 12 (or to a service orchestration function, if such is implemented separately from the SAS(s) 12). Here and elsewhere in this disclosure, unless otherwise specified or apparent from the context, any phrase referring to “A or B” shall be understood as meaning either A or B, or both A and B.

Consequently, the computer system 90 may provide conformance information to the BSS(s) and to the SAS(s). Indeed, there may be one or more types of conformance information comprised in the conformance information generated by the computer system and it may provide different types of conformation information to different recipient systems.

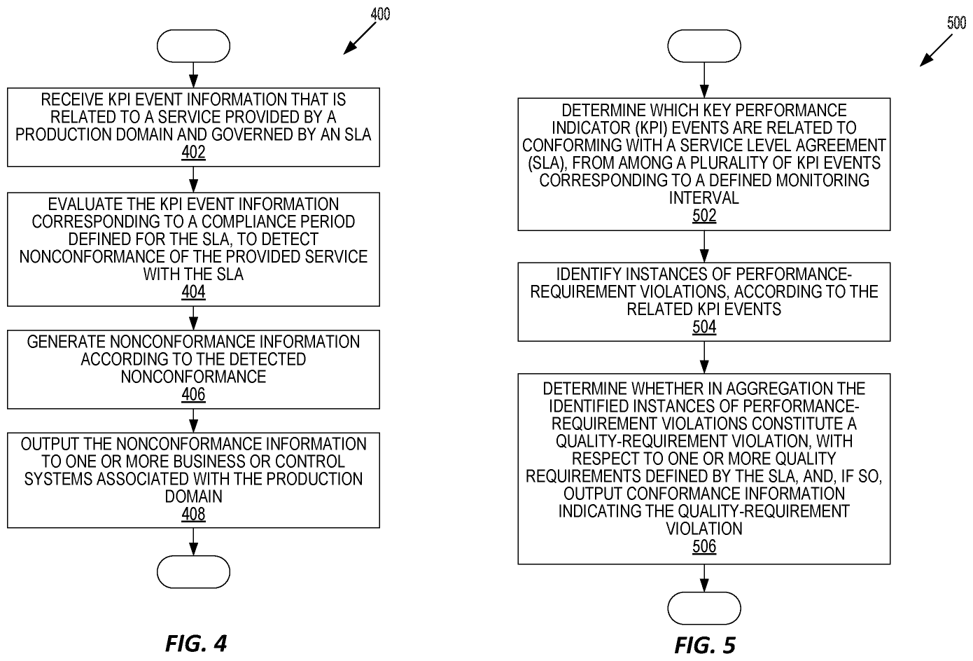

One embodiment comprises a method 400 performed by a computer system associated with a production domain 16. FIG. 4 illustrates the method 400, which includes the following steps or operations:
receiving (Block 402) KPI event information that are related to a service that is provided by a production domain and governed by a SLA;
evaluating (Block 404) the KPI event information corresponding to a compliance period defined for the SLA, to detect nonconformance of the provided service with the SLA;
generating (Block 406) nonconformance information according to detected nonconformance; and
outputting (Block 408) the nonconformance information to one or more business or control systems associated with the production domain 16.

In one or more embodiments, the nonconformance information indicates particular points of nonconformance, with respect to SLOs defined by the SLA. In one or more embodiments, the nonconformance information indicates an extent or degree of nonconformance. In one or more embodiments, the nonconformance information includes cost information expressing a cost of the detected non-conformance in monetary or non-monetary terms.

FIG. 5 illustrates another embodiment comprising a method 500 performed by a computer system associated with a production domain. The method 500 may be regarded as an alternative to or an implementation example of the method 400 and it includes the following steps or operations:
determining (Block 502) which KPI events are related to conforming with a SLA, from among a plurality of KPI events corresponding to a defined monitoring interval;
identifying (Block 504) instances of performance-requirement violations, according to the related KPI events; and
determining (Block 506) whether in aggregation the identified instances of performance-requirement violations constitute a quality-requirement violation, with respect to one or more quality requirements defined by the SLA, and, if so, outputting conformance information indicating the quality-requirement violation.

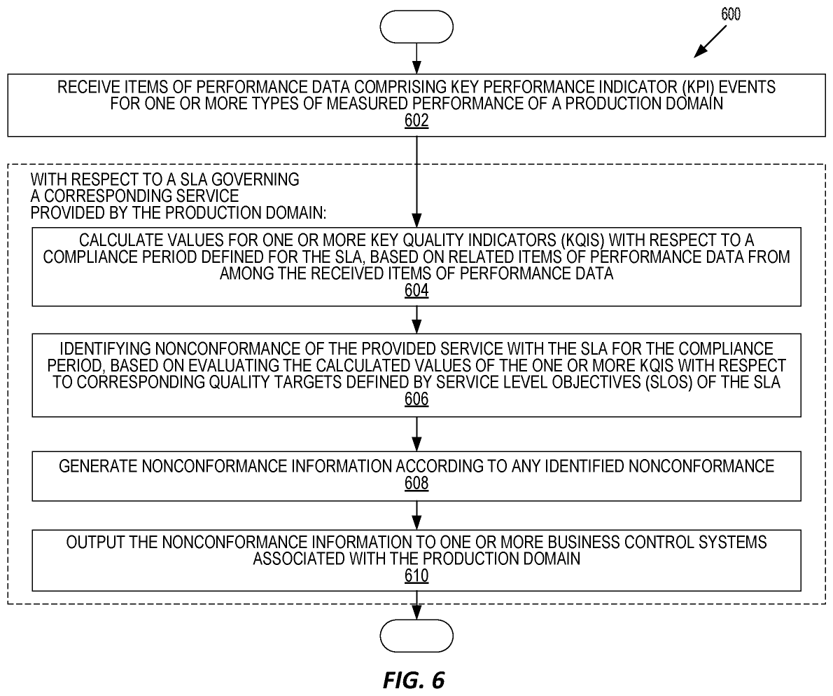

Another embodiment appears in FIG. 6 and comprises a method 600 which may be understood as an alternative to the two preceding illustrated methods, or as a detailed example implementation of either of such methods. The method 600 includes the following steps or operations:
receiving (Block 602) items of performance data comprising KPI events for one or more types of measured performance of a production domain; and
with respect to a SLA governing a corresponding service provided by the production domain:
calculating (Block 604) values for one or more Key Quality Indicators (KQIs) for a compliance period defined for the SLA, based on related items of performance data from among the received items of performance data;
identifying (Block 606) nonconformance with the SLA for the compliance period, based on evaluating the calculated values of the one or more KQIs with respect to corresponding quality targets defined by Service Level Objectives (SLOs) of the SLA;
generating (Block 608) nonconformance information according to any identified nonconformance; and
outputting (Block 610) the nonconformance information to one or more business or control systems associated with the production domain.

The nonconformance information indicates, for example, one or more actions to be taken with respect to the identified nonconformance. In a particular example, the nonconformance information indicates any one or more of a monetary amount to be refunded to a customer associated with the affected SLA, a service credit to be awarded to the customer, or weights or priority indications to be used by a SAS in making future resource management decisions for the production domain with respect to providing the service.

The nonconformance information in one or more embodiments comprises consequence data indicating one or more consequences arising from the identified nonconformance. For example, the one or more business or control systems associated with the production domain comprise a BSS associated with charging the service associated with the SLA, and the nonconformance information expresses the cost of the identified nonconformance in terms of monetary or service-usage credit. As another example which may be practiced in combination with or as an alternative to the immediately prior example, the one or more business or control systems associated with the production domain comprise a SAS associated with management of resources in the production domain for conformance with the SLA, and the nonconformance information expresses the cost of the identified nonconformance in terms of resource management priorities to be applied by the SAS during one or more future monitoring periods.

Calculating the values for the one or more KQIs in one or more embodiments comprises identifying, from the related KPI events, times or instances in the defined monitoring period during which a performance or quality target defined by the one or more SLOs was not met and determining whether the cumulative effect of such nonconformance over the defined monitoring period violates a compliance target defined by the one or more SLOs. In this sense, the SLA manager assesses the aggregate or top-level effect of performance shortfalls with respect to an overall compliance period. One advantage of such functionality is that even low-level KPIs can be monitored or otherwise evaluated, to calculate the aggregate or overall effect on KQIs corresponding to SLOs in the SLA.

Consider an example case where the production domain is a communication network, and the network provides a communication service to a customer according to a SLA. The example SLA includes a Service Level Specification (SLS) that defines an availability requirement of 95%, meaning that the communication service must be available for 95% of the time, with respect to a compliance period, e.g., a month. Thus, the SLS can be understood as defining a SLO of 95% availability.

In an example definition, the “availability” is defined in terms of session success rate and packet error/loss rate—i.e., the communication service is considered available at any given instant if the session success rate is above a defined threshold and the packet error/loss rate is below a defined threshold. KPI event information flowing directly or indirectly from the production domain to the SLA manager includes information indicating short-term or instantaneous session success rates (KPI1) and packet error/loss rates (KPI2).

However, the customer is not interested per se in the short-term or instantaneous performance of the communication network, and instead wants to know whether the communication network provides an overall availability for the compliance period that satisfies the relevant SLO(s) in the SLA. Hence, the SLA manager calculates a KQI1 corresponding to KPI1 and a KQI2 corresponding to KPI2 by accumulating or aggregating the KPI event information for KPI1 and KPI2, for the compliance period. To assess whether the availability SLO was met for the compliance period, the SLA manager compares the calculated value of KQI1 (i.e., the overall session success rate for the compliance period) against the minimum success rate defined by the SLO, and compares the calculated value of KQI2 (i.e., the overall packet error/loss rate for the compliance period) against the maximum error/loss rate defined by the SLO.

Other types of production domains may have different KPIs and corresponding KQIs, SLOs, and SLSs. Consider a cloud computing center as an example production domain, which offers computing services to its customers. A SLA in this context may include a SLS having SLOs relating to the number of computing jobs completed per second, average job delay, etc., with all such requirements being defined against a compliance period that is generally much longer than the underlying period(s) associated with KPI measurement within the cloud computing center.

Turning back to other aspects of the method, a method according to one or more embodiments comprises receiving the items of performance data as batched data and using timestamp information in the items of performance data to identify particular items of performance data that correspond to the defined monitoring period. The method according to one or more embodiments comprises receiving the items of performance data in real-time or near-real-time during the defined monitoring period. In at least one embodiment, the method includes the computer system receiving some items of performance information in batched form and receiving other items of performance information in real-time or near-real-time during the monitoring/compliance period at issue.

In one or more embodiments, the method comprises the computer system receiving the items of performance data from a SAS of the production domain.

In at least one embodiment, the SLA information comprises one or more data structures that link particular values of one or more identifiers to particular SLAs, and the method comprises determining which one or more SLAs are affected SLAs with respect to each item of performance data received at the SLA manager, based on indexing into the one or more data structures using the values of corresponding identifiers included in or provided with the incoming items of performance data. The one or more identifiers comprise one or more of: a service identifier, a network slice identifier, a Subscription Permanent Identifier (SUPI), a device or device group identifier, or a 5QI value. Additional or other identifiers may be used, in a lesser or greater number. In at least one embodiment, the particular identifier(s) to be used for relating KPI event information to SLAs may be configured or selected, e.g., by an authorized person associated with the production domain.

Further, it will be appreciated that the particular number and type(s) of identifiers used for correlating items of performance data reported for the production domain with SLAs will depend on the nature of the production domain and involved services. In any case, it will be appreciated that a SLA may specify a particular value or range for one or more types of identifiers, such as service identifiers, customer identifiers, etc., and that items of performance data incoming to the SLA manager 10 may include or be provided with values for the same types of identifiers, such that the SLA manager 10 identifies a particular item of performance data as being related to a particular SLA based on matching the identifier values associated with the item of performance data with the identifier values specified for the SLA. Herein, referring to an item of performance data as being related to a particular SLA is equivalent to saying that that SLA is an “affected SLA” with respect to that item of performance data—i.e., that item of performance data involves an underlying KPI on which one or more KQIs of the SLA depend.

Thus, in one or more embodiments of a method performed by a SLA manager 10, one of the processing operations is correlating identifier values carried in or provided in association with incoming items of performance data with identifier values (of the same type or category) that are specified for one or more SLAs, e.g., a plurality of SLAs, to identify which SLAs are affected by the respective items of incoming performance data. Of course, a given item of performance data may be related to multiple SLAs, such that there are overlapping sets of performance-item data being evaluated with respect to multiple SLAs, to determine conformance or nonconformance with each such SLA.

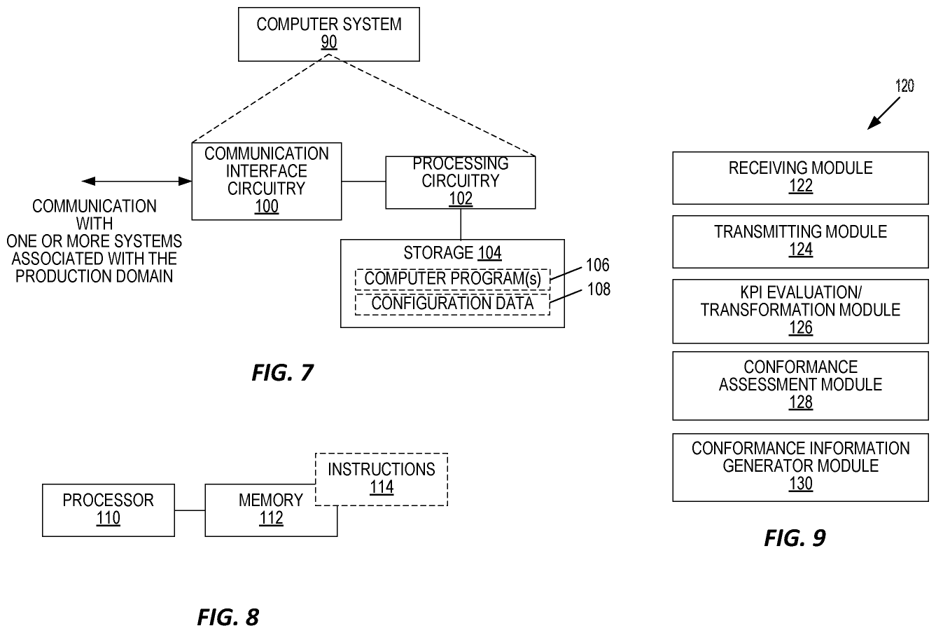

FIG. 7 illustrates example implementation details for a computer system 90 that is operative as a SLA manager 10. The computer system 90 includes communication interface circuitry 100 and processing circuitry 102 that is operatively associated with the communication interface circuitry 100. Here, “operatively associated” means that the processing circuitry 102 sends or receives messages, signaling, or other information via the communication interface circuitry 100, e.g., receives items of performance data for evaluation and outputs conformance information based on evaluating the items of performance data.

In one or more embodiments, a production domain 16 with which the computer system 90 is associated is a telecommunication network. For example, the telecommunication network is a wireless communication network, such as a wireless communication network configured for operation in accordance with Third Generation Partnership Project (3GPP) technical specifications, and the services governed by corresponding SLAs are communication services provided by or through the telecommunication network. In a particular example, the production domain is a 3GPP wireless network operating according to the Fifth Generation (5G) technical specifications and may comprise a 5G New Radio (NR) RAN, along with a 5G Core (5GC).

In another embodiment, the production domain 16 is a data center, and the services governed by corresponding SLAs are data-center services, such as data-processing services or data-storage services. As another example, the production domain 16 is a cloud processing environment, and at least one service provided by the cloud processing environment comprises a virtualized core network (CN) service or virtualized radio access network (RAN) service that provides processing for traffic or control operations in a wireless communication network. As another example, the production domain 16 is a web server or web-service hosting environment and a SLA of interest guarantees, for example, that a certain number of HTTP transactions per second can be performed. Of course, the computer system 90 may provide SLA management functionality with respect to two or more production domains 16 of the same or different types, and may use respective configuration data—SLA information, etc.—tailored for the different types of production domains 16.

The processing circuitry 102 of the computer system 90 may comprise, at least in part, fixed circuitry, or programmatically-configured circuitry, or a mix of the two. In at least one embodiment, the processing circuitry 102 comprises one or more processors (e.g., microprocessors or DSPs or other digital processors) that is/are specially adapted to carry out any or all of the SLA management operations described herein according to respective ones of the various embodiments, based on executing computer program instructions stored in a memory, e.g., a working memory containing instructions transferred from longer-term storage.

As such, in one or more embodiments, the computer system 90 includes storage 104, e.g., for storing one or more computer programs 106 along with any relevant configuration data 108, such as SLA information representing one or more SLAs, configuration information for generating nonconformance information, etc. The storage 104 comprises one or more types of computer-readable media. FIG. 8 provides an example depiction of the processing circuitry 102 being implemented based on one or more processors 110 interfacing with a memory 112 that holds computer-program instructions 114, for execution by the processor 110.

The computer system 90 in one or more embodiments may be implemented as a set 120 of processing units or modules, which may be understood as logical functions instantiated using underlying physical processing resources, but which may be realized in a virtual computing environment. FIG. 9 offers an example depiction of a set 120 of processing modules configured to carry out the steps or operations of any of the method embodiments described herein. Such modules include a receiving module 122 configured for receiving items of performance data and a transmitting module 124 configured for outputting nonconformance information, and where the receiving module 122 and the transmitting module 124 may also provide for other types of information exchange.

Further included in the set 120 is a KPI evaluation/transformation module 126 that is configured to evaluate items of performance data provided for a production domain 16, and to transform or otherwise process that information for determination of whether the performance of the production domain 16 conforms to SLOs defined by a SLA for a service provided via the production domain 16. “Transformation” here broadly refers to the use of KPI events that are from a compliance period of interest and relevant to a SLA, to determine values for one or more KQIs for which the SLA stipulates KQI targets. Other modules include a conformance assessment module 128 and a conformance information generator modulator 130.

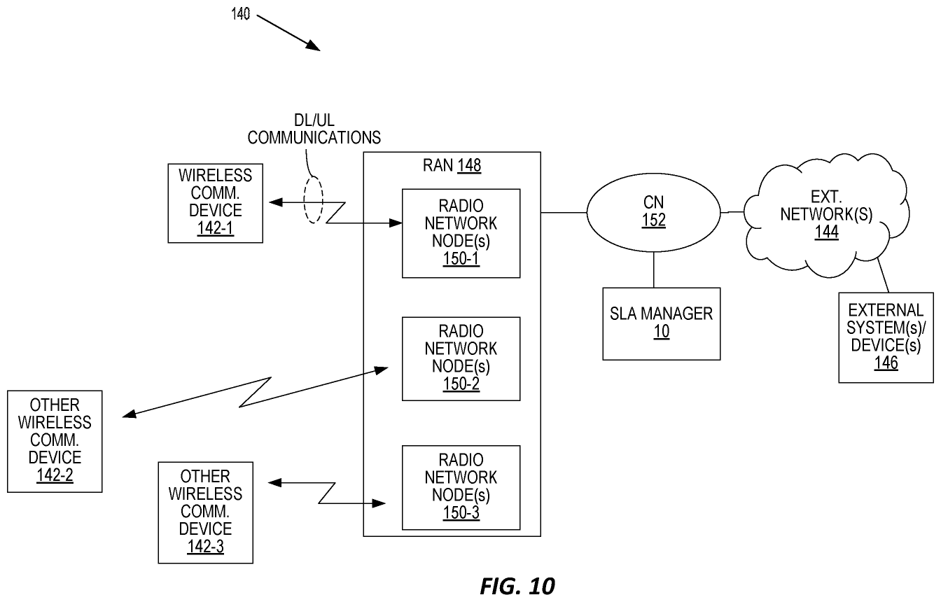

FIG. 10 depicts an example wireless communication network 140 as a production domain 16, where the network 140 provides one or more types of communication services to wireless communication devices 142, e.g., to respective devices 142-1, 142-2, and 142-3, which may belong to the same subscriber or different subscribers and which may use the same service governed by one SLA or different services governed by respective SLAs. For example, the network 140 functions as an access network and communicatively couples the wireless communication devices 142, which also may be referred to as “user equipments” or “UEs”, to one or more external networks 144, such as the Internet.

The external network(s) 144 provides access to one or more external systems or devices 146, e.g., one or more types of data servers or other equipment. In an example scenario, one or more of the devices 142 are Machine-to-Machine (M2M) devices and the external systems/devices 146 include one or more M2M domains. As such, the “services” provided by the communication network in an example embodiment may be understood as communication or carrier services, where such services may be governed according to SLAs that stipulate certain SLOs, e.g., with respect to connectivity, reliability, and performance.

The RAN 148 includes radio network nodes 150, with nodes 150-1, 150-2, and 150-3 shown by way of example. A CN 152 provides the communicative coupling to the external network(s) 144. The CN 152 includes or is associated with a SLA manager 10.

As a particular example of SLA management, an enterprise customer pays for use of a network “slice” provided by a communication network, e.g., a 5G communication network. The network slice can be understood as being a logical or virtualized network based on underlying network infrastructure that may be shared among multiple slices. The network operator may sell network slices according to SLAs that establish various overall quality-of-experience metrics, which are then monitored or assessed by the SLA manager, as described herein. In such example, the production domain may be understood as the network slice in question, or the underlying network, and service produced for the customer is the networking service(s) provided by the slice.

In another example, a customer uses a communication service provided through the wireless communication network, and a corresponding SLA defines one or more quality requirements that the network must meet with respect to providing the service. A subscriber may be associated with one UE or with a population of UEs, such as where the subscriber is a factory operator and uses the wireless communication network for interconnecting various control and monitoring system via wireless links.

In one example, the SLA manager receives KPI event information, which may comprise indications of violations and clearances of defined KPI thresholds, such as uplink (UL) throughput or downlink (DL) throughput, latencies within the wireless network, jitter, connection-success rates, etc. In an example case, “UL” refers to traffic/transmissions from customer equipment to the network, and “DL” refers to traffic/transmissions from the network to the customer equipment.

To better understand the evaluations performed by the SLA manager, consider the following example framework:
a SLA defines Quality-of-Experience (QoE) requirements in terms of one or more SLOs;
each SLO defines a performance target for one or more corresponding KQIs, such as overall throughput provided for a communication service, and defines a compliance target for meeting the performance target, e.g., a compliance target requires that the performance target be met for a defined percentage of the timespan of the compliance period at issue, such as 95% of the compliance period;
each KQI may be directly represented by a KPI, or it may be an amalgamation or transformation of two or more KPIs of different types, e.g., a KQI for overall throughput may be based on respective KPIs for UL and DL throughput; and
the items of performance data provided by SAS(s) to the SLA manager may comprise KPI event information in the form of performance measurements, such as UL or DL throughput measurements made per minute or may comprise indications of instances when a KPI threshold is violated and corresponding indications of violation clearances.

To better understand the foregoing, consider a case where a SLA includes an SLO that establishes a throughput target for overall throughput and establishes a compliance target for providing/achieving the throughput target. The SLA manager receives KPI event information regarding UL and DL throughput for the involved service and determines times (instances of noncompliance) for the compliance period when the overall throughput target is not met, and it aggregates or otherwise accumulates those times for the compliance period, to see whether the violations in the aggregate exceed the amount or extent of noncompliance permitted by the compliance target. As such, individual occurrences of performance thresholds for KPIs do not necessarily mean that a SLA is being violated, and the SLA manager must evaluate the KPI information for the compliance period in question to determine whether the aggregate or overall effect of any performance violations during the compliance period result in nonconformance with the SLA.

Note that the apparatuses described herein may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

### Section 1

Referring back the Customer and Partner SLA Management function in the example of FIG. 2 as one embodiment of a SLA manager 10, the SLA management functionality involves five distinct services.
1. SLA Life Cycle management service, responsible for Lifecycle management of SLAs for single domain and hybrid domain services integrated to external Catalog Management and CRM systems.
2. SLA routing service, responsible to receive the KPI events from Service assurance system in real time or near real time or batch mode, determine impacted SLAs and SLOs from these KPI events and is responsible to flag the event as KPI threshold violation or KPI threshold clearance event. These events are then passed to SLA evaluation service for further processing.
3. SLA evaluation service, responsible to receive the events from SLA routing service for each SLA impacted, monitor the service quality objectives by transforming events on KPI threshold violation and KPI threshold clearance to KQI events, comparing the calculated KQI values against KQI thresholds, calculation the time periods during which the KQI targets have been violated; these time periods will then be related to the conformance period and the conformance level specified on the SLO, the KQI is linked towards; the SLA evaluation service is executed at the end of the conformance period or on continuous basis for each SLA consider events from multiple service assurance systems from different production domains.
4. Consequence determination service, responsible to determine the consequences to be applied for a service degradation detect by the SLA evaluation service.
5. Consequence handling service is responsible for life cycle management of the consequences, including triggering of the application with external systems of consequences.

The SLA management function is integrated towards external BSS functions
a. by exposing an API for SLA Life cycle management;
b. by exposing an API for consequence management; and
c. by exposing an API for consequence publication.

The SLA management function integrates towards external CRM systems and Catalog Management systems for reference data retrieval which are needed for SLA evaluation.

The SLA management function integrates towards various service assurance systems for receiving KPI events supporting pattern 1 and pattern 2 as described in Section 2, using the Event adapter API.

### Section 1.1—Informational Entities

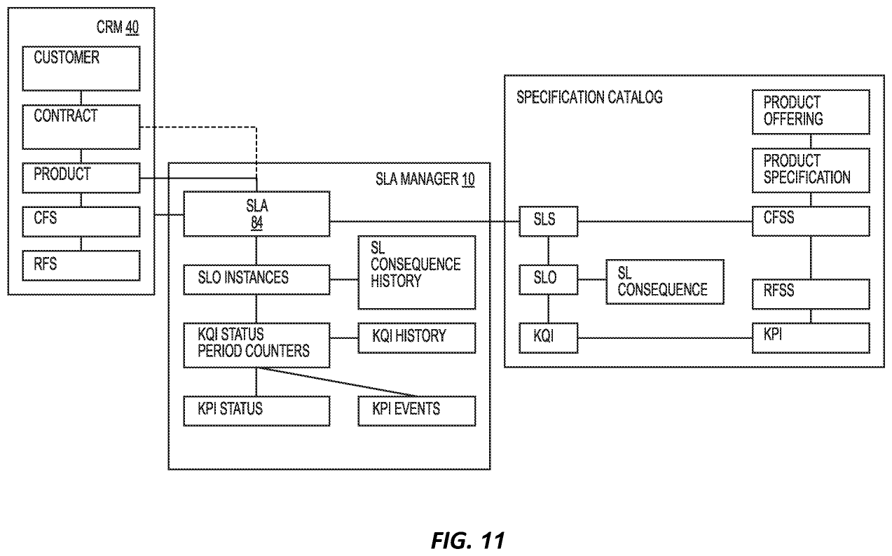

A SLA manager is responsible to monitor the SLAs signed between a service provider and customers of the service provider. The SLAs generally are binding legal agreements. The relationship of the information entities and the systems responsible to manage SLAs in terms of monitoring for compliance and generating nonconformance information for application of network controls or billing adjustments is depicted in the high level conceptual diagram provided as FIG. 11.

The external CRM system 40 is responsible for managing the customer base, the contracts signed as well as the installed base of products, customer facing services (CFS) and resource facing services (RFS). The SLA 84 is negotiated during an ordering process and instantiated in the SLA Manager 10. Saying that the SLA 84 is instantiated in the SLA manager 10 means that information representing the SLA 84 is provisioned within the SLA manager 10, e.g., for conformance monitoring and generation of nonconformance information.

The SLA manger 10 monitors the SLA 84 and maintains an instance for each service level objective (SLO) defined in the associated SLS. For each SLO defined by the SLA 84, there is an SLO instance for which the SLA manager 10 maintains corresponding compliance-period counters for the KQI status, KQI history, KPI status, and KPI event information, as well as the history of service level consequences determined. The specification artifacts originate from a specification catalog, which maintains the SLS linked to customer facing service specifications (CFSS).

### Section 2

### Section 2.1—Method for SLA Instantiation and Preparation for SLA Identification

Order management functions instruct the SLA Manager 10 to instantiate a SLA 84 as agreed between the service provider associated with the production domain 16 and the customer or supplier. The SLA manager 10 in one or more example embodiments exposes a public REST API for life cycle management of the SLAs, including reading, creating and updating SLAs.

Here, “REST” denotes Representational State Transfer.

The SLA manager 10 uses so-called adapters to integrate with external systems like Customer and Partner Management (CPM adapter) and towards the Specification Catalog (Catalog adapter) to retrieve reference information.

A lookup table (noted in Section 2.3) is prepared and it allows determination of “impacted” SLAs and their SLOs, with respect to items of performance data incoming to the SLA manager 10. That is, although FIG. 11 illustrates one SLA 84 and its associated SLO instances, counters, historical data, etc., there may be multiple SLAs 84, each with a corresponding set of data structures/data items, for management of each such SLA 84 by the SLA manager 10. Further, any particular item or items of performance data incoming to the SLA manager 10 from a SAS 12 or other production-domain monitoring system may relate to a certain one or more SLAs 84 being managed by the SLA manager 10 but not relate to one or more other SLAs 84 being managed by the SLA manager 10.

Here, an item of performance data “relates” to a SLA 84 if one or more of the KQIs represented by the SLOs of the SLA 84 involves a KPI represented by that item of performance data. This disclosure thus refers to a given SLA 84 as being related to certain items of performance data, or being impacted by such data, or being affected by such data. In one or more embodiments of the SLA manager 10, one of the data processing operations performed by the SLA manager 10 is identifying related, impacted, or affected SLAs 84 with respect to incoming items of performance data.

Such performance data has or is provided in conjunction with properties and service identifiers that the SLA manager 10 in one or more embodiments uses as lookup values, to correlate items of performance data with the SLAs 84 that it is managing, to identify which SLAs 84 are affected by which items of performance data. In this sense, performance data incoming to the SLA manager 10 may carry or be accompanied by specific values for one or more types of identifiers, e.g., a service ID, and the SLA manager 10 may use such values as “correlation identifiers” by evaluating its stored SLA information to determine which SLAs 84 are associated with the same (matching) identifier values.

A correlation identifier may be a logical resource but could also be a non-unique classification. They may be initially configured with the service specification or granted to a service instance and addresses a specific classification or traffic filtering aspect, which is subject to monitoring in the production domain 16 by a SAS 12.

The correlation identifiers are included in the items of performance data reported by one or more SASs 12 to a SLA manager 10, in one or more embodiments. Such items comprise, for example, KPI measurements/breach events. The correlation identifiers allow the SLA manager 10 to identify which SLAs 84 are impacted by which items of data.

The following identifiers on a service serve as correlation identifiers, in one or more embodiments:
a. Service ID (as granted during service provisioning orchestration and present in network inventory, where “network inventory” is a digital representation of the network of a service provider, in terms of network functions and deployed network services);
b. Single Network Slice Selection Assistance Information (S-NSSAI), e.g., as specified during service definition or granted during service provisioning orchestration when instantiating the service;
c. Service ID+S-NSSAI; and
d. Combination of a) or b) with 5QI, where “5QI” denotes standardized QoS identifier values used in 5G networks.

If the SLAs are specified for a service which is limited to a single device or a group of devices, the SUPI (subscription permanent identifier) or the identifier of the device group might be considered. A prerequisite here is that the SAS 12 that provides performance data to the SLA manager 10 is capable of monitoring the traffic of specific devices. In such cases, the correlation identifiers in one or more embodiments are extended as indicated below:
e. Device group identifier
f. Combination of a) or b) with device group identifier
g. Combination of a) or b)+device group identifier+5QI
h. Combination of a) or b)+SUPI (where “SUPI” denotes Subscription Permanent Identifier)
i. Combination of a) or b)+SUPI+5QI
j. Other alternative identifiers for service, NW slice or QoS flow identification and combinations with the above. Other identifiers, such as “coverage area” or other service-related identifiers may be used.

The correlation identifiers e), f), g) and h) combine service level resources with device or device-group identification. The device-related identifiers are only applicable if specific device level monitoring is applied.

The correlation identifiers may be combined to form a correlation set that includes service ID, S-NSSAI, 5QI, and device group. Regular expressions are used as placeholders, in case certain properties out of the foregoing list are not applicable for the service at issue—i.e., not all such identifiers will be applicable for a given SLA-governed service. For example, a indicates NULL or any value, a “?” indicates that any value must be present, and a “!” represents a NULL value. An example correlation set is demonstrated in the example described in Section 2.1.1.

Adding a KPI identifier to the correlation set is optional. The benefit of adding KPI identifiers or otherwise making a more exacting set of correlation identifiers is that a smaller set of impacted SLAs is identified in the first step of the SLA routing service described in Section 2.3. One drawback of doing so is that the lookup table(s) increase in size, because a separate entry must be created for each KPI. Also, doing so requires analysis of the structure of the SLS linked to the SLA when creating table entries in the lookup table.

Another point to note is that the particular combinations of correlation identifiers to be used and supported by the SLA manager 10 depend on the details of the SAS(s) 12 that provide performance data to the SLA manager 10, the nature of the services governed by the SLA(s) 84 being managed by the SLA manager 10, and, more broadly, the nature of the production domain(s) 16 involved in providing such services. At least some of the correlation-identifier examples given herein assume that the production domain 16 is a telecommunication network such as a 3GPP 5G network or a network slice provided via a 3GPP 5G network.

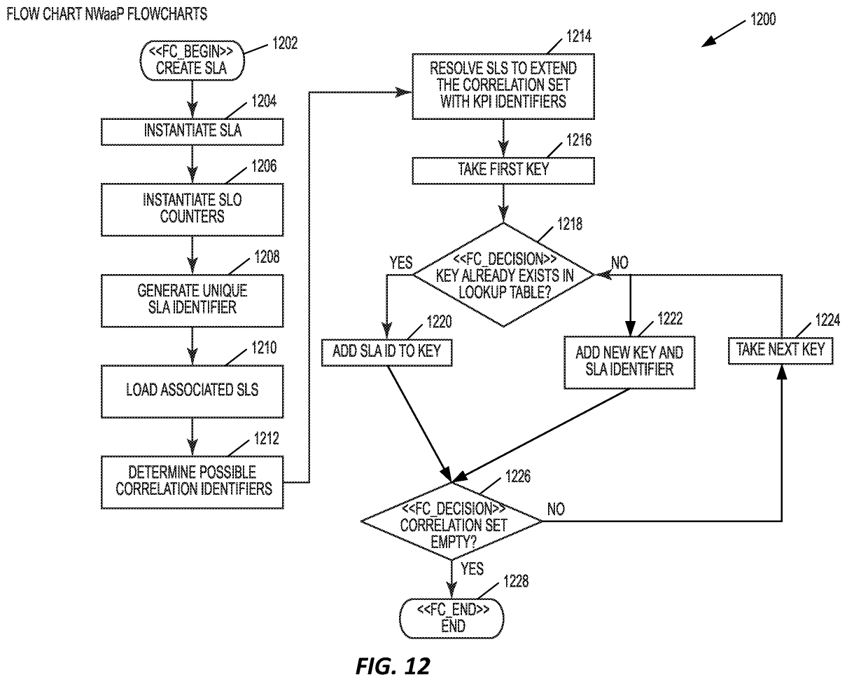

FIG. 12 depicts a method 1200 comprising steps or actions that are executed according to one embodiment of a SLA manager 10. Assuming creation of a SLA (Block 1202), the operations include:
a. instantiate Service level agreement with service level objective counters referring to the service instance with objectives and generate unique SLA identifier (Block 1204);
b. instantiate SLO counters for assessing conformance/nonconformance (Block 1206);
c. generate unique SLA identifier (Block 1208)
d. load associated SLSs (Block 1210);
e. determine possible correlation identifiers (Block 1212);
f. resolve SLS references to service, for extending set of correlation identifiers with relevant KPI identifiers (optional if KPI-extended correlation identifier set is to be used) (Block 1214); and
g. prepare lookup table for correlation identifiers (Blocks 1216, 1218, 1220, 1222, 1224, 1226, and 1228).

With respect to item g, for each of the possible combinations of correlation identifiers (as listed above) a new entry in the lookup table is created, which refers to the SLA, or an existing entry is updated, and the SLA identifier is added if not already present in the list. The resulting lookup table maps the supported combinations of the lookup values onto a list of (potentially impacted) SLAs.

The lookup table in one or more embodiments caters to scenarios where items of performance data incoming to the SLA manager 10 may contribute to (relate to) multiple SLAs. Such situations may exist where a network service is not exclusively assigned to a single customer but serves traffic of different customers in parallel, where the different customers have different SLAs in place.

### Section 2.1.1—Example

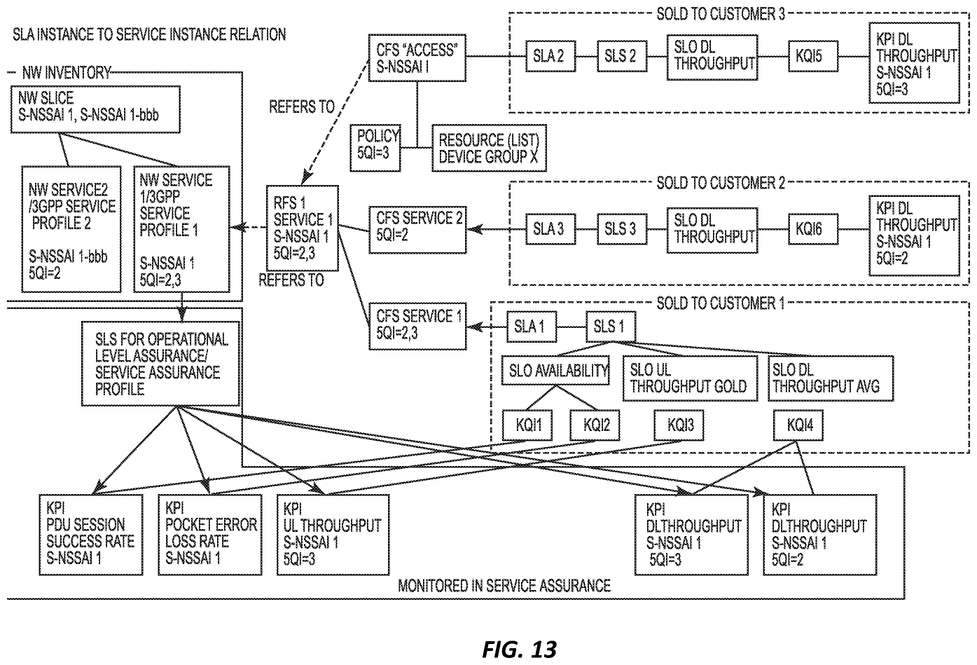

The example depicted in FIG. 13 illustrates a network (NW) slice, supporting 2 NW services, each of them identified by a different S-NSSAL. There is also a consumer service depicted, which is called “access” service. Only NW service “service 1” is used in the following discussion. This NW service is identified by S-NSSAI 1 and supports two different 5QI values.

There are 3 different SLAs (with associated SLS) to be instantiated, in this working example. The different SASs 12 in action annotate the performance data they report with correlation identifiers for Service ID and S-NSSAI, and 5QI, if applicable. If monitoring is done for device subscription group, the correlation identifiers provided in or with the performance data will also include the device subscription group.

When the SLA manager instantiates respective SLAs, the corresponding correlation lookup table(s) are populated. For example, when instantiating SLA 1, the following table entries will be created using a logical configurable sequence of correlation identifiers:

| Correlation identifiers | SLAs |
|---|---|
| 1, 1, *, *, success rate | SLA1 |
| 1, 1, *, *, loss rate | SLA1 |
| 1, 1, 3, *, UL throughput | SLA1 |
| 1, 1, 3, *, DL throughput | SLA1 |
| 1, 1, 2, *, DL throughput | SLA1 |

In the above table, the correlation identifiers in each row are, going from left to right “service ID”, “S-NSSAI”, “5QI”, SUPI/device group identifier, and KPI. The value “*” denotes a “don't care” or ignore condition, meaning that the correlation identifier corresponding to that position in the logical order is not used in the correlation. Thus, going from left to right in row 1 of the above table, the first “1” indicates a service ID of 1, the second “1” denotes a S-NSSAI of 1, the first “*” indicates that the 5QI value is not considered in the correlation, and the second “*” indicates that the SUPI/device group identifier is not used in the correlation.

Continuing the example, when instantiating SLA 2, the correlation lookup table must be updated. New entries will be created pointing to SLA 2. This SLA 2 (as described in FIG. 13) is not defined for a NW service (as SLA 1) but rather defined for a whole group of devices (group X), which will run their traffic on a NW service identified by S-NSSAI=1 and will use the 5QI=3 for RAN traffic prioritization. For example:

| Correlation identifiers | SLAs |
|---|---|
| 1, 1, *, *, success rate | SLA1 |
| 1, 1, *, *, loss rate | SLA1 |
| 1, 1, 3, *, UL throughput | SLA1 |
| 1, 1, 3, *, DL throughput | SLA1 |
| 1, 1, 2, *, DL throughput | SLA1 |
| *, 1, 3, X, DL throughput | SLA2 |

In addition, the table is prepared in a way such that measurements collected for certain device groups can also contribute to SLAs for the underlying NW service.

When instantiating SLA 3, various entries in the lookup table for NW service 1 must be updated, such as:

| Correlation identifiers | SLAs |
|---|---|
| 1, 1, *, *, success rate | SLA1 |
| 1, 1, *, *, loss rate | SLA1 |
| 1, 1, 3, *, UL throughput | SLA1 |
| 1, 1, 3, *, DL throughput | SLA1 |
| 1, 1, 2, *, DL throughput | SLA1, SLA3 |
| *, 1, 3, X, DL throughput | SLA2 |

The example above uses the KPI values to extend the set of correlation identifiers, but, again, such extension is optional. Note that if the KPI values are omitted from the lookup table, they are used in a second step by the SLA routing service of the SLA manager 10, to find the impacted KQI(s) and SLO(s).

Section 2.2—Example Methodology to Integrate SLA Management with Service Assurance

In an example scenario, the SAS(s) 12 that report performance data from a production domain to the SLA manager 10 do so by collecting measurements from various sources, combining and averaging the collected data to calculate end2end KPIs on a service level, and comparing the resulting values against preconfigured thresholds that represent KPI-level requirements—i.e., a KPI target, which may be a low-level performance target within the production domain 16. On a violation or clearance, the involved SAS 12 raises events towards service and resource management for automated service healing. The KPI violation indications and corresponding clearance indications represent one type of performance data that may be incoming to the SLA manager 10—i.e., items of performance data may be notifications of a KPI violation and subsequent corresponding notifications that the violation is cleared. In such cases, the SLA manager 10 may keep track of violations and corresponding clearances to time the duration or extent of given violations.

In more detail, there may be two basic patterns used to integrate SLA management by the SLA manager 10 with different SASs 12. These patterns may be referred to as Pattern 1 and Pattern 2.

Pattern 1 is an incident pattern, and it is used to pick up events raised by service assurance on violation of thresholds or clearance of such violations, as determined for service performance measurements. Pattern 2 is a measurement pattern and it is used to process data for service performance measurements received on continuous basis from service assurance. In other words, performance data incoming to the SLA manager 10 in the context of Pattern 1 comprises indications or notifications of KPI violations and corresponding clearances of those violations, for any number or type of KPIs being assessed by the involved SASs 12.

In such cases, the SLA manager 10 must track the durations between violations and corresponding clearances to calculate the impact of KPI violations, e.g., how long the violation condition persisted for each indicated violation and/or the aggregate duration of violations for a particular KPI, e.g., as aggregated over a compliance period relevant to one or more SLAs that are affected by those violation.

Contrastingly, performance data incoming to the SLA manager 10 in the context of Pattern 2 comprises performance measurements for one or more KPIs or types of KPIs, and the SLA. These measurements may have a fine temporal granularity and they may be a stream or batch of measurements made at regular intervals. With respect to Pattern 2 data, the SLA manager 10 in one or more embodiments is configured with performance thresholds for the KPIs being monitored and it performs comparison of the KPI measurements against the relevant thresholds, to determine the occurrences and durations of KPI violations. Such occurrences and durations may then be accumulated or otherwise aggregated, e.g., using counters or other accumulators, with respect to one or more SLA compliance periods, to determine the aggregated effect on the related SLAs (as done by the SLA manager 10 with the Pattern 1 data). One way to view the Pattern 2 data processing is that the SLA manager 10 effectively translates Pattern 2 data into Pattern 1 data, for assessment of the aggregate effect of KPI violations over one or more SLA compliance periods.

Pattern 1 requires an initial retrieval of service performance measurements to initialize the algorithms for service quality calculation in SLA management. Pattern 2 requires the monitoring system to support a publish/subscribe mechanism such that SLA manger can register for continuous updates on measurement data.

Exposing KPIs of services has not been the focus of various standardization efforts, and also not with the specification of 5G by the 3GPP. Thus, there are no standardized APIs adopted in the existing art to support Pattern 1 or Pattern 2 types of integration. Thus, the integration mechanisms for Patterns 1 and 2 require high flexibility to allow for adapting to different types of SASs 12.

The items of performance data received by the SLA manager 10, “events”, carry the following information in one or more embodiments:
Information about SLO(s)
   Preferable explicit reference to the SLO(s),
   the SLO combines KPI, comparison operation, one or many thresholds with threshold types
Information about the KPI
   KPI identifier or identifier of intermediate computed performance indicator
Event information
   timestamp
   Event type (measurement, violation, recovery, error);
   Current value
   (List of) Threshold crossed with values with types, if reference to SL objective is not included
Event correlation identifiers
   Reference to monitored entity: list of pairs (identifier+type), e.g. (S-NSSAI,<value>), (service identifier,<value>)
   Other correlation identifiers: 5QI, QCI

The event handling function of the SLA manager 10 in one or more embodiments supports an adapter pattern. There will be at least one instance of an adapter per SAS 12 to which the SLA manager 10 interfaces. Integration Pattern 1 or 2 is selected for each respective SLA in dependence on the ability of the respective SAS 12 to expose service performance measurements and information about detected violations of thresholds on service KPIs.

The event handling function contains service assurance adapters supporting the various integration methods for the two patterns, for example:
1. Message bus adapter (Kafka & JMS compliant) allowing to receive events from service assurance systems on pattern 1 (incidents) and pattern 2 (measurements)
2. REST adapter, allowing to retrieve data from service assurance systems on pattern 1 (incidents) and pattern 2 (measurements), synchronous and asynchronous including registration/notification functionality
3. BATCH adapter, allowing to import files containing data from service assurance systems on pattern 1 (incidents) and/or pattern 2 (measurements) Once the event has been successfully received by the event handling function of the SLA manager 10, it will delegate that to a SLA evaluation function of the SLA manager 10, for determination of the impacted SLAs.
   Section 2.3—Methodology to Determine Affected SLAs for Events from One or Many SASs

According to one or more embodiments, the SLA evaluation function of the SLA manager 10 applies various operations to the performance data incoming to it from a SAS 12. For example, the SLA evaluation function:
1) Filters events on “service level” (see below).
2) Extracts correlation identifiers from events.
3) Applies lookup algorithms to collect supersets of impacted SLAs.
4) Determines impacted SLOs using the SLS structure of SLSs linked to respective SLAs.

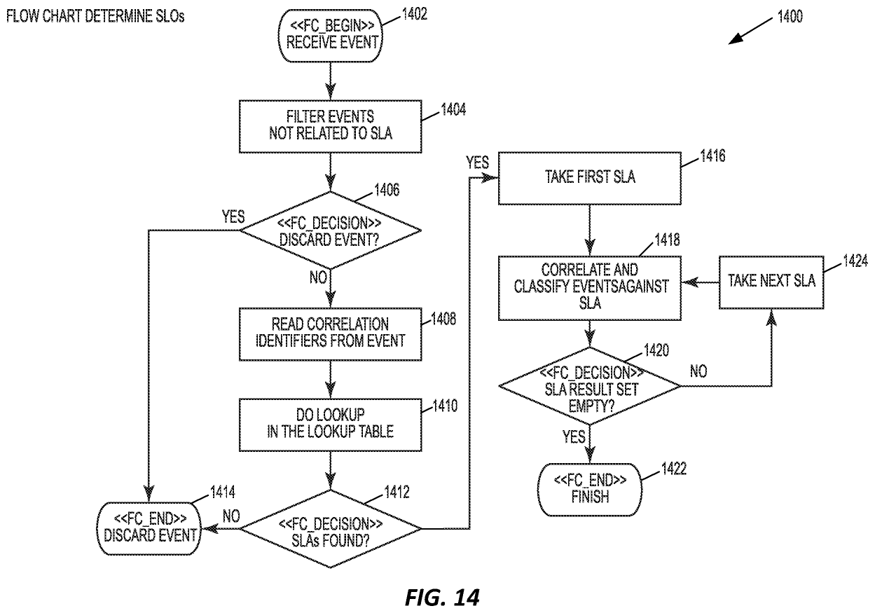

The steps 1-4 form a reusable SLA router functionality of the SLA manager 10 and FIG. 14 provides an example of the logic to be executed in the form of a method 1400. In the context of the method 1400, an “event” is an item of performance data, e.g., KPI event data.

The method 1400 embodies the above steps 1-4 and includes receiving one or more events (Block 1402), filtering the event(s) to eliminate events not related to any SLAs being managed by the SLA manager 10 (Blocks 1404, 1406, and 1414). For the event(s) remaining, the SLA manager 10 reads correlation identifiers from the events (Block 1408), and attempts to identify SLAs that are related to (impacted or affected by) the event(s) (Blocks 1410, 1412, 1416, 1418, 1420, 1422, and 1424).

With respect to the method 1400, the SLA 10 manager limits its processing to events which are related to SLAs under its supervision. Thus, it must apply a filtering mechanisms to extract events belonging to event types for services, which are paired with a SLA. This step is necessary if the integration described in Section 2.2 results in a superset of events made available to SLA manager. That is, there are scenarios or implementations where the SLA manager 10 will receive items of performance data that are not necessarily related to any SLAs being managed by it.

Identifying events that are relevant to one or more managed SLAs is based in one or more embodiments on the SLA manager 10 reading correlation identifiers provided in the events. Based on the correlation identifiers provided in the events, the SLA manager 10 performs a lookup in the lookup table to identify the SLAs against which the event needs to be evaluated for SLA conformance.

On finding multiple SLAs impacted by any particular event, the event will be evaluated against each impacted SLA one by one, by the SLA evaluation function of the SLA manager 10. This scenario can happen if events are triggered from services that are shared among multiple customers having respective SLAs. As noted, each such SLA will be associated with SLOs and corresponding quality targets for one or more KQIs, with the SLA manager 10 using performance data reported to it for the KPIs on which those one or more KQIs depend, to determine conformance or nonconformance with the SLA.

With respect to a compliance period for a SLA, the SLA manager 10 may receive performance data during the compliance period, or it may receive performance data after the compliance period, where such data nonetheless reflects performance during the compliance period. In one example with respect to a monitoring period, the SLA manager 10 receives events carrying information about incidents on KPI thresholds or intermediate computed performance indicators (according to Pattern 1) or KPI measurements or measurements from intermediate computed components (according to Pattern 2).

When receiving events, the SLS routing service of the SLA manager 10 extracts the KPI identifiers and the correlation identifiers and forms the correlation sets to be used for identifying which events are related to which SLAs being managed. The identification algorithm explained below is one example of possible implementations, but not limited to it. All algorithms implemented need to have the ability to match events to fully or partially qualified correlation sets.

The following sample algorithm can be applied:

Loop through all “columns/parts” of the correlation set extracted from an event and compare the values:
1) If the incoming event has a value, select all keys that have:
   a) The same value
   b) A ‘*’
   c) A ‘?’
   d) But not a ‘!’
2) If the incoming vector has NULL (no value), the keys must be selected that have
   a) ‘*’
   b) ‘!’
3) The intersection of the result-sets of all elements gives the impacted SLAs (which might be one SLA, multiple SLAs, or none).

The SLA manager 10 processes the entries of the lookup table and determines the superset of impacted SLAs. The example below illustrates that more than one SLA can be impacted by events received.

All SLAs found will be worked off in a loop.

For each SLA, the associated SLS structure is retrieved and analyzed bottom up. The KPI named in the event is used to find the KQI it contributes towards, as well as the impacted SLO(s).

The event will be annotated with the identifiers of KQI and SLO. The event will also be analyzed with regards to whether the event indicates a threshold violation or clearance.

### Section 2.3.1—Example

Reference back to FIG. 13 provides an opportunity to illustrate an example algorithm resulting in the following content of the lookup table used by the SLA manager 10.

| | Correlation | |
|---|---|---|
| | identifiers (service, S- | |
| | NSSAI, 5QI, device | |
| | group, KPI type) | SLAs |
| 1 | 1, 1, *, *, success rate | SLA1 |
| 2 | 1, 1, *, *, loss rate | SLA1 |
| 3 | 1, 1, 3, *, UL | SLA1 |
| 4 | 1, 1, 3, *, DL | SLA1 |
| 5 | 1, 1, 2, *, DL | SLA1, SLA3 |
| 6 | 1, 1, 3, X, DL | SLA2 |

Of course, the lookup table may be realized according to a number of different data structures or logical arrangements, such as a tree or graph structure.

Sample events are depicted below having the simplified properties: Service, S-NSSAI, 5QI, device group, KPI type, value/incident:
1. (1, 1, NULL, NULL, loss rate, 1%)
2. (1, 1, 3, X, DL, 50 mbs)
3. (1, 1, 2, NULL, DL, 10 mbs)
4. (1, 1, 2, NULL, DL, 50 mbs)
5. (NULL, 1, NULL, NULL, DL, 30 mbs)

When receiving event #2 (1, 1, 3, X, DL, 50 mbs), SLA 1 will be identified as impacted by matching lookup table entry #3 and SLA 2 will be identified as impacted by matching lookup table entry #6.

When receiving event #3 indicating a violation of the KPI for DL throughput for S-NSSAI 1 and 5QI=2, the table entry #5 will be hit, showing that SLA 1 and SLA3 are impacted.

The same logic happens for event #4.

Once a SLA is selected, the SLA routing service of the SLA manager 10 uses the KPI identifier to identify the impacted SLO instances.

### Section 2.4—Methodology to Calculate Conformance Level for Service Quality Objectives Out of KQI in Relation to Conformance Period

The SLA evaluation service of the SLA manager 10 is responsible for initially identifying impacted KQIs and then applying the KPI transformation and aggregation functions, to calculate the impact of KPI violation events (Pattern 1) or KPI measurement events (Pattern 2) on the impacted KQIs.

The identification of the impacted KQIs leverages the relationship between KQI and KPI, which is specified in the SLS, which is maintained in a specification catalog. The catalog defines the relationships between KQIs and KPIs by configuring which KPIs contribute to which KQIs and which transformation functions to use when calculating the impact of KPI violations on the related KQIs. The catalog also specifies potential filter criteria for KPIs, e.g., specific 5QI values.

KQIs can be combined out of multiple KPI measurements using a transformation function. An example SLO defines one or more KQI targets, as well as a % of a time period (called conformance target) during which the KQI target(s) must be achieved.

The transformation functions defined in the SLA management component including their applicability to KPIs are imported into the catalog and then added to the KQI definition upfront.

The SLA management component of the SLA manager 10 initially defines and executes the transformation function that are used for KQI calculation. The transformation function will determine how different KPIs contribute to the determination of KQI. The transformation function can be fully or partially defined in SLA management function. Details on a transformation function are given below.

The transformation function can be any of the following types:
i) A parameterized function which accepts KPIs as parameters and specifies and limits which KPIs can be combined to a KQI. The catalog should in this case be able to define the sequence of KPI input into the function.
ii) A dedicated function that is tailor made for specific KQIs. Such a function will only be compatible with 1 category of KQI and will only allow the catalog to associate the function to target KQI.
iii) Predefined (simple) operators that can be processed by SLA management function. Specification catalog will have to import these operators and then assemble them into an expression that can be understood by SLA Management function.
Example (one for positive): combine latency and throughput for availability
Example (negative): what cannot be combined: combine latency and UL throughput for end2end throughput

Following are high level descriptions of the KQI logic on incoming KPI events or when a monitoring period is over.

### Section 2.4.1—Common Initialization for Pattern 1 and 2:

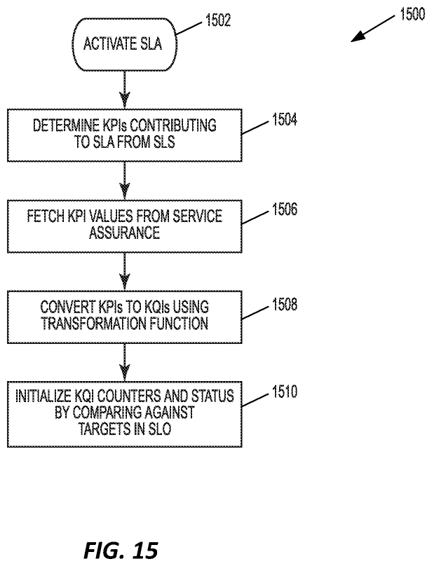

The operations depicted in FIG. 15 as a method 1500 include activating a SLA (Block 1502), determining the KPIs that are related to the SLA, based on information in the SLS (Block 1504), fetching or otherwise receiving KPI values from a SAS (Block 1506), converting the KPI values to KQI values using one or more transformation functions (Block 1508), and initializing KQI counters and status by comparing the KQI values against corresponding KQI targets defined by the one or more SLOs specified in the SLA (Block 1510).

More generally, when a SLA becomes effective the KQI counters must be initialized. To do so the SLS specifying the KQIs and the KPIs contributing to them is evaluated. For all KPIs contributing to a KQI configured in the SLS the current value is fetched from the probe and compared to the KPI threshold. The KPI values are handed over to the transformation function and the KQI is calculated.
a. If the fetched value is below the threshold, the KQI state is initialized with state green
b. If the fetched value is above the threshold the KQI state is initialized with state red
c. The KQI state timestamp is set to the response timestamp of the interrogation response
   Section 2.4.2—Pattern 1: Reporting of breach or clearance events from Service Assurance Systems

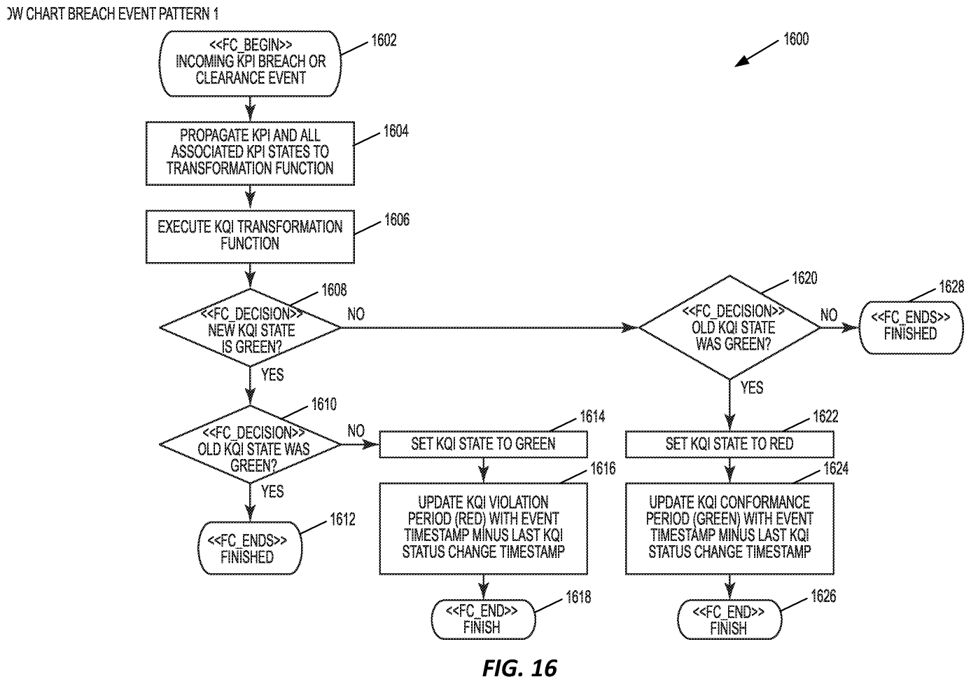

FIG. 16 depicts example processing in the context of Pattern 1, for reporting of breach or clearance events from SASs.

The illustrated method 1600 begins in conjunction with the SLA manager 10 receiving an incoming KPI breach or a corresponding clearance event (Block 1602) and propagating the KPI and all associated KPI states to the applicable transformation function (Block 1604). Processing continues with executing the transformation function (Block 1606) and determining from the resulting KQI value whether the new KQI state (used by the SLA manager 10 for monitoring the state of the involved KQI with respect to a particular SLA) is green or red. Green means that the KQI value obtained via KPI transformation meets the requirement defined by the corresponding KQI target, as specified by the one or more SLOs of the SLA. Red means that the KQI value does not meet the requirement. Processing continues with the SLA manager 10 updating KQI violation period counters or trackers (red state) or updating KQI conformance counters or trackers (green state). See Blocks 1608, 1610, 1612, 1614, 1616, 1618, 1620, 1622, 1624, 1626, and 1628.

In simple terms, the SLA manager 10 in one or more embodiments processes KPI events via one or more translation or transformation functions to determine whether respective KQI targets of a SLA are being met, based on maintaining logical state representations corresponding to conformance and nonconformance states and accumulating times or instances of nonconformance. The accumulation provides for assessing the aggregate effect of individual instances or times of KPI conformance, with respect to a compliance period. In more detail:
1. For each SLA monitoring or conformance evaluation period (e.g., a monthly period), the SLA Evaluation service maintains a timeline for each KQI conformance state.

The time periods when a calculated KQI value was compliant to the SLA-defined KQI target are tallied as green periods and the time periods when the calculated KQI value was non-compliant are tallied as red periods. The timeline of red and green periods helps in easily calculating the % of the time the SLA was breached and deciding on applicability of any consequences.
2. Each KQI has counters for green time periods and for red time periods per monitoring period (with new monitoring periods new counters are created).
3. When a SLA becomes effective, SLA manager must actively interrogate the state of each new KPI and calculate the KQI and KQI state associated with the KPI; this state (green or red) together with the response timestamp is taken as the initial state of the KQI.
4. All incoming KPI events from Service Assurance must be propagated to the KQI transformation, since breaches are determined on KQI level.
5. The KPI event must be propagated towards the KQI it contributes to by applying the configured transformation function.
   a. In case multiple different KPIs contribute to a KQI, the latest KPI events must be retrieved and passed to the transformation function together with the KPI event received.
   b. The KPI event results in a KQI event, which must reflect the KQI threshold achievement or breach. The KQI threshold is retrieved from the SLO.
6. The KQI calculated with the help of transformation function will be compared against the threshold configured on SLO level. Depending on the KQI previous state the following actions need to happen:
   a. If KQI state was green and no violation detected, KQI counters will not be changed.
   b. If KQI state was green and now a violation has been detected the KQI state in SLA manager is set to red and the KQI state timestamp is set to the breach event timestamp. The KQI compliance counter time period must be closed. The difference of the violation event timestamp and the green KQI state timestamp is added to the green counter of the KQI. The KQI violation counter time period starts running.
   c. If KQI state was red and a further was violation detected, KQI counters will not be changed.
   d. If KQI state was red and clearance of violation has been detected the KQI state in SLA manager is set to green and the KQI state timestamp is set to the clearance event timestamp. The KQI violation counter time period must be closed. The difference of the clearance event timestamp and the red KQI state timestamp is added to the red counter of the KQI. The KQI compliance counter time period starts running.
7. When detecting that the monitoring period is over, the KQI logic must execute the following:
   a. The difference between the end of monitoring timestamp and the KQI state timestamp is added to the counters of the last period indicated by the KQI state (state red->red counter, state green->green counter)
   b. New counters for the new monitoring period are created
   c. The KQI state timestamp is set to the period over timestamp; the KQI state is kept
8. Note that the period over logic must be executed before a new breach or clearance event after the end of the period can be processed.

### Section 2.4.3—Pattern 2: Continuous Value Measures

In the context of Pattern 2, the incoming performance data represents measurements rather than violation/clearance indications, and the SLA manager 10 evaluates whether the reported values indicate breaches of KPI targets. KPI measures may come into the SLA manager 10 on regular intervals, which means that the SLA manager 10 may not be able to resolve the precise time at which a KPI threshold was violated—e.g., one measurement for a particular KPI is not in violation of the applicable KPI target but the next one is, meaning that the violation occurred sometime during the measurement interval.

An example SLA manager 10 includes two processing paths: one path for performance data constituting KPI violation and clearance indications (Pattern 1), and one path for performance data constituting KPI measurements (Pattern 2). Alternatively, the SLA manager 10 may have one or the other such processing path. In implementations where the SLA manager 10 includes a Pattern-2 processing path, the SLA manager 10 compares the values of incoming KPI measurements (sample values) with the corresponding applicable KPI thresholds (to which it will have access):
a. If a sample value is higher than the KPI threshold
   i. If the KPI state is red, the event can be discarded
   ii. If the KPI state is green, create a breach event
b. If the sample value is lower than the KPI threshold
   i. If the KPI state is green, the event can be discarded
   ii. If the KPI state is red, create a clearance event
c. If a breach or clearance event exists, set the event timestamp to the middle of the period between the last sample and this sample's timestamp
d. If a breach or clearance event exists, feed it into pattern 1 algorithm

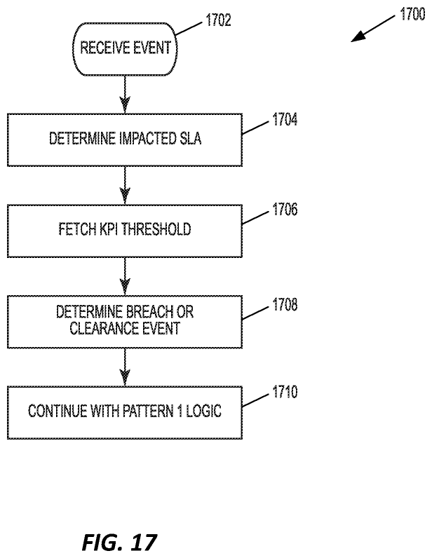

FIG. 17 depicts one example of processing in relation to continuous-value measures (Pattern-2 path processing). The depicted method 1700 includes receiving a KPI event (Block 1702), which shall be understood as an item of performance data comprising a KPI measurement—i.e., the received KPI event is a measurement value, along with various associated information, such as correlation identifiers, time stamps, etc. The method 1700 continues with determining the impacted SLAs (Block 1704) and, for each impacted SLA, fetching the corresponding KPI threshold (Block 1706), determining whether the measurement value reflects a breach or clearance event for the KPI (Block 1708), and then continuing with the Pattern-1 logic (Block 1710). Continuing with the Pattern-1 logic means following the processing described above for the scenario where incoming items of performance data are KPI violation/clearance indications.

### Section 2.5—Methodology to Determine and Select Consequences for Violations of Service Quality Objectives

Once a compliance period for a SLA is over, the KPI red/green periods logically maintained by the SLA manager 10 for the SLA are evaluated according to the requirements defined by the KQI targets and conformance targets set out in the SLOs of the SLA, to determine whether the service in question was provided in conformance with the SLA during the compliance period. Here, it is worth appreciating that KQIs define quality measurements and the SLO(s) of the SLA establish corresponding targets for the KQIs. However, the SLO will, as a general proposition, also set out requirements defining an extent of compliance required or expected.

For example, the SLA manager 10 calculates KQI values from reported KPI information and records whether the calculated KQI values meet the requirements defined by the KQI targets. For the overall compliance period, the SLA manager 10 may track or accumulate instances or durations of nonconformance with respect to each of the KQIs defined in the SLA being managed. For example, one such KQI may be data throughput and the SLA may define a specific target for data throughput. With respect to the compliance period and tracking of calculated values for the throughput KQI based on underlying KPI event information spanning the compliance period, the SLA manager 10 determines, for example, the percentage of time during the compliance period that the data throughput met or fell below the data throughput target.

While any instance of falling below the data throughput target may be deemed nonconformance in some sense, the SLA will, in general, define a compliance target or requirement that is used to assess whether KQI nonconformance constitutes a breach of the SLA. For example, using the data throughput KQI as an example, the SLA may specify that the SLA is met—i.e., that service during the compliance period conformed to the SLA-if the data throughput did not fall below the requirement for more than X % of the compliance period.

Further, the SLA may define or otherwise allow for degrees or levels of violation, and the nonconformance information generated by the SLA manager 10 may account for such sophistications or nuances. For example, in embodiments where the SLA manager 10 is configured with “consequence actions” to be triggered in response to detecting nonconformance with a SLA, the consequence may depend on the level of violation, either measured as deviation of actual KQI value towards the target or measured as a deviation in time compared to the conformance period.

Determined consequences will be persisted for various reasons:
1) Memorize consequences, in case they are configured to be triggered automatically
2) Persist consequences to allow triggering on demand or delayed and allow for later modification (via consequence management API)
3) Memorize consequences to be able to feed back determined implications to service assurance systems (via a consequence management API of the SLA manager 10).

While the SLA manager 10 may determine the consequences, the consequences are enforced by external systems, not by the SLA manager 10. An example enforcement methodology is described in Section 2.6.

In addition, the various SASs will be notified respectively or can poll for consequences determined (by invoking the consequence management API), such that they include insights on commercial implications of service orchestration actions in the closed loop service assurance algorithms. In any case, the consequence of nonconformance with a SLA is realized as consequence actions. The consequences actions might be providing a discount (credit amount) in the next bill or a compensation product etc. It can also be a notification being sent to SLA Administrator for that customer or directly to customer.

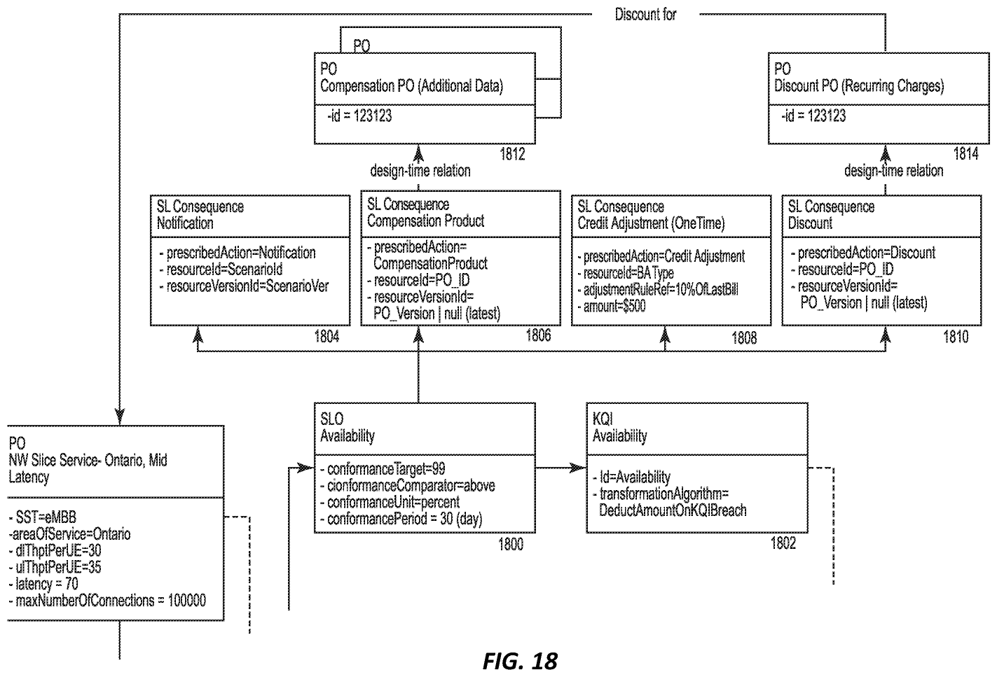

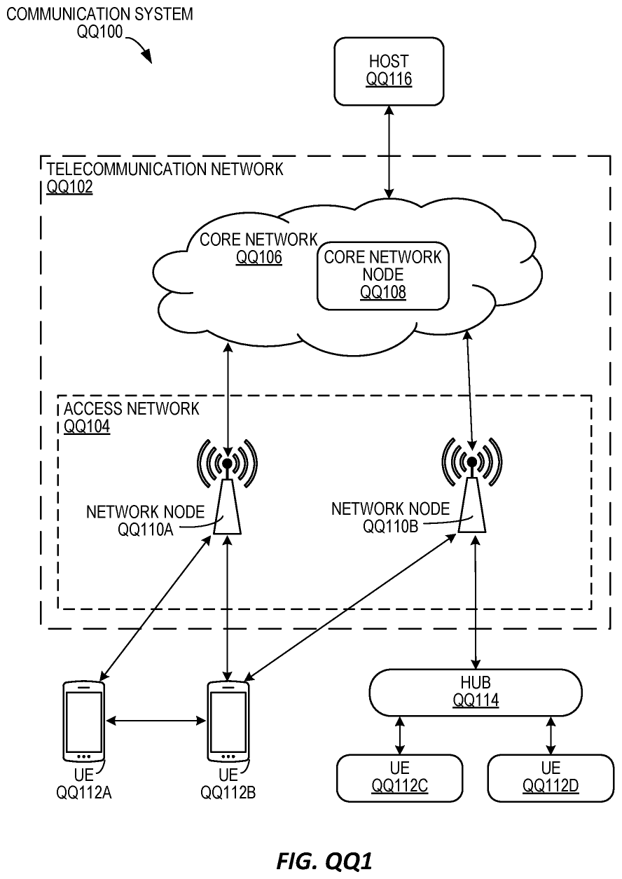

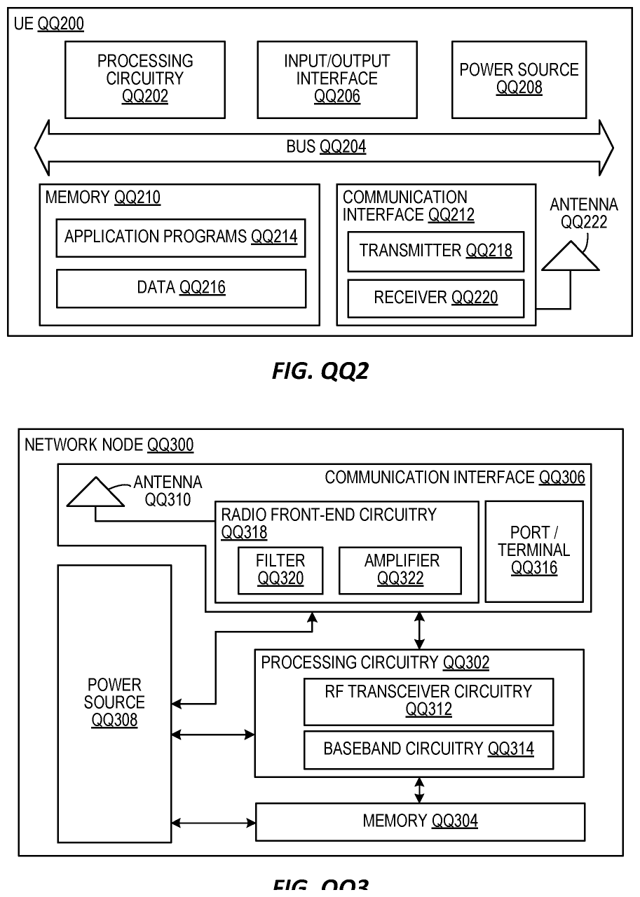

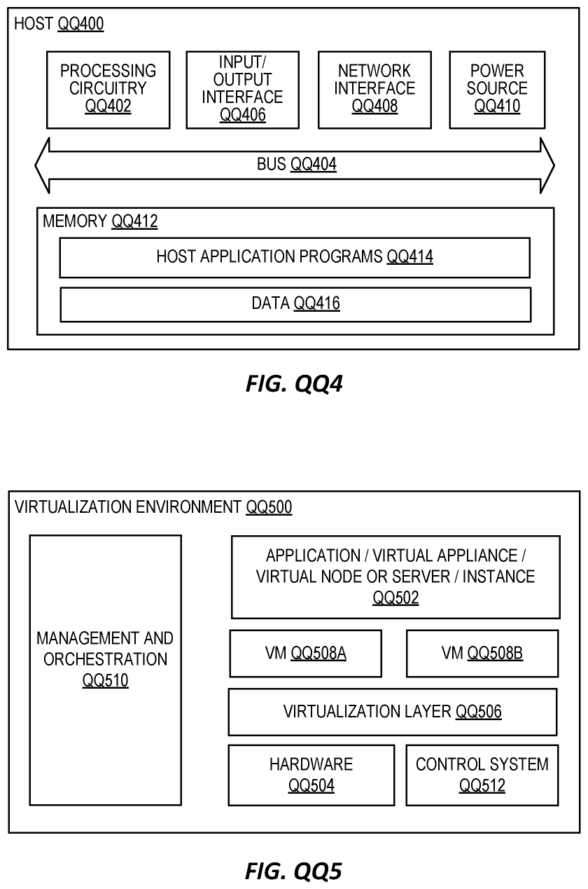

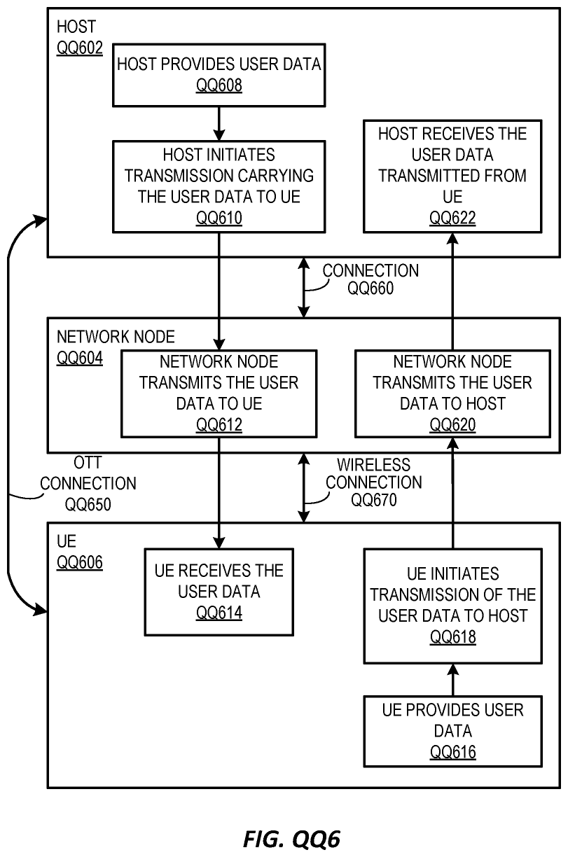

FIG. 18 provides a view of example consequences actions which can be configured if the SLO objectives are breached. The application method (automatically, manually, delayed) can be specific to the consequence action to be triggered. The illustrated flow includes blocks or actions 1800, 1802, 1804, 1806, 1808, 1810, 1812, 1814, and 1816.

Section 2.6—Methodology to Notify External Systems about Consequences Determined

Consequences are modeled in the specification catalog and associated with the service level objectives. This specification identifies the possible consequence actions. In detail the consequence model in Specification catalog will contain the following:
a) Consequence type (ex. Notification, credit adjustment etc.)
b) Identifiers to represent resources that are to be used by the consequence action.
c) A map of the resource identifiers and their corresponding dependencies as
   i. static input
   ii. placeholders that will be resolved at runtime by the SLA management function.

The SLA management function is integrated towards an external specification catalog via the catalog adapter integration point and retrieve the consequence definitions from there.

The SLA management function will resolve the consequence objects that are defined in the catalog into fully constructed consequence objects by replacing the artifact dependency placeholders with real values. The fully constructed consequence object can then be used in either of the following fashion to trigger the consequence:
i) SLA management function can publish the consequence object in an enterprise event bus and expect the target systems to subscribe and listen to these consequence topic messages. This method would fully decouple the consequence type and its execution.
ii) The exposures of consequence actions are not limited to an integration via enterprise event bus. Other methods for publishing the consequence actions, even direct integration to BSS functions responsible to enforce the consequence actions, are possible,
iii) SLA management function can convert the resolved consequence objects into point-to-point requests to target systems that execute the consequence. This method will require the SLA management function to be aware of the contract required to integrate with the consequence enforcement points.

Although the subject matter described herein may be implemented in any appropriate type of system using any suitable components, the embodiments disclosed herein are described in relation to a wireless network, such as the example wireless network illustrated in Figure QQ1.

FIG. QQ1 depicts a telecommunication network QQ102, which includes an access network QQ104 and a core network QQ106. The core network QQ106 includes one or more core network nodes, e.g. a core network node QQ108. The access network QQ104 includes one or more access network nodes, e.g., network nodes QQ110A and QQ110B. The network nodes QQ110A and QQ110B comprise, for example, radio network nodes that support communication with wireless devices, e.g., User Equipment (UE) QQ112A and UE QQ112B, or with a hub QQ114 that provides wireless connectivity for one or more UEs, e.g., UE QQ112C and UE QQ112D. The telecommunication network QQ102 may support communications between UEs, which are also referred to as wireless devices, or between a wireless device and another communication device, such as a landline telephone, a service provider, or any other network node or end device. The wireless network may provide communication and other types of services to one or more wireless devices to facilitate the wireless devices' access to and/or use of the services provided by, or via, the telecommunication network QQ102, which also may be referred to as a wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standards, such as the Worldwide Interoperability for Microwave Access (WiMAX), Bluetooth, Z-Wave and/or ZigBee standards.

Network QQ102 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node(s) QQ110 and respective ones of the UEs, also referred to as wireless devices or “WDs”, comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

FIG. QQ2 illustrates one embodiment of a UE in accordance with various aspects described herein. Unless noted or clear from the context, the terms “user equipment”, “UE”, “wireless device”, and “WD” are all interchangeable. Further, as used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE QQ200 may be any UE identified by the 3rd Generation Partnership Project (3GPP), including a NB-IoT UE, a machine type communication (MTC) UE, and/or an enhanced MTC (eMTC) UE. UE QQ200, as illustrated in FIG. QQ2, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeably. Accordingly, although FIG. QQ2 is a UE, the components discussed herein are equally applicable to a WD, and vice-versa.

In FIG. QQ2, UE QQ200 includes processing circuitry QQ202 that is operatively coupled to input/output interface QQ206, e.g., via a bus QQ204. A power source QQ208 provides power for various components of the UE QQ200.

Other included components include memory QQ210 and a communication interface QQ212. The memory QQ210 may store one or more application programs QQ214 and data QQ216, and the communication interface QQ212 in an example embodiment includes one or more transmitters QQ218 and one or more receivers QQ220, which are associated with one or more transmit/receive antennas QQ222.

In FIG. QQ2, processing circuitry QQ202 may be configured to process computer instructions and data. Processing circuitry QQ202 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored programs, general-purpose processors, such as a microprocessor or Digital Signal Processor (DSP), together with appropriate software; or any combination of the above. For example, the processing circuitry QQ202 may include two central processing units (CPUs). Data may be information in a form suitable for use by a computer.

In the depicted embodiment, input/output interface QQ206 may be configured to provide a communication interface to an input device, output device, or input and output device. UE QQ200 may be configured to use an output device via input/output interface QQ206. An output device may use the same type of interface port as an input device. For example, a USB port may be used to provide input to and output from UE QQ200. The output device may be a speaker, a sound card, a video card, a display, a monitor, a printer, an actuator, an emitter, a smartcard, another output device, or any combination thereof. UE QQ200 may be configured to use an input device via input/output interface QQ206 to allow a user to capture information into UE QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. QQ2, communication interface QQ212 may be configured to provide a communication interface to RF components such as the illustrated transmitter QQ218 and receiver QQ220.

FIG. QQ3 illustrates a network node QQ300, according to an example embodiment, e.g., either of QQ110A or QQ110B shown in FIG. QQ1. The example network node QQ300 includes processing circuitry QQ302, memory QQ304, a communication interface QQ306, and a power source QQ308. The network node QQ300 as illustrated is an example embodiment, and it is to be understood that a network node comprises any suitable combination of hardware and/or software needed to perform the tasks, features, functions and methods disclosed herein. Moreover, while the components of network node QQ300 are depicted as single boxes located within a larger box, or nested within multiple boxes, in practice, a network node may comprise multiple different physical components that make up a single illustrated component (e.g., memory QQ304 may comprise multiple separate hard drives as well as multiple RAM modules, and may thus represent one or more types of computer-readable storage media).

Similarly, network node QQ300 may be composed of multiple physically separate components (e.g., a NodeB component and a RNC component, or a BTS component and a BSC component, etc.), which may each have their own respective components. In certain scenarios in which network node QQ300 comprises multiple separate components (e.g., BTS and BSC components), one or more of the separate components may be shared among several network nodes. For example, a single RNC may control multiple NodeBs. In such a scenario, each unique NodeB and RNC pair may, in some instances, be considered a single separate network node. In some embodiments, network node QQ300 may be configured to support multiple radio access technologies (RATs). In such embodiments, some components may be duplicated and some components may be reused (e.g., the same antenna QQ310 may be shared by different RATs). Network node QQ300 may also include multiple sets of the various illustrated components for different wireless technologies integrated into network node QQ300, such as, for example, GSM, WCDMA, LTE, NR, Wi-Fi, or Bluetooth wireless technologies. These wireless technologies may be integrated into the same or different chip or set of chips and other components within network node QQ300.

Processing circuitry QQ302 is configured to perform any determining, calculating, or similar operations (e.g., certain obtaining operations) described herein as being provided by a network node. These operations performed by processing circuitry QQ302 may include processing information obtained by processing circuitry QQ302 by, for example, converting the obtained information into other information, comparing the obtained information or converted information to information stored in the network node, and/or performing one or more operations based on the obtained information or converted information, and as a result of said processing making a determination.

Processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide the node functionality. For example, processing circuitry QQ302 may execute instructions stored in memory QQ304. Such functionality may include providing any of the various wireless features, functions, or benefits discussed herein. In some embodiments, processing circuitry QQ302 may include a system on a chip (SOC).

In some embodiments, processing circuitry QQ302 may include one or more of radio frequency (RF) transceiver circuitry QQ312 and baseband processing circuitry QQ314. In some embodiments, radio frequency (RF) transceiver circuitry QQ312 and baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

In certain embodiments, some or all of the functionality described herein as being provided by a network node, base station, eNB or other such network device may be performed by processing circuitry QQ302 executing instructions stored in memory QQ304. In alternative embodiments, some or all of the functionality may be provided by processing circuitry QQ302 without executing instructions stored on a separate or discrete device readable medium, such as in a hard-wired manner. In any of those embodiments, whether executing instructions stored on a device readable storage medium or not, processing circuitry QQ302 can be configured to perform the described functionality. The benefits provided by such functionality are not limited to processing circuitry QQ302 alone or to other components of network node QQ300 but are enjoyed by network node QQ300 as a whole, and/or by end users and the wireless network generally.

Memory QQ304 may comprise any form(s) of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ302. Memory QQ304 may store any suitable instructions, data or information, including a computer program, software, an application including one or more of logic, rules, code, tables, etc., and/or other instructions capable of being executed by processing circuitry QQ302 and utilized by network node QQ300. Memory QQ304 may be used to store any calculations made by processing circuitry QQ302 and/or any data received via communication interface QQ306. In some embodiments, processing circuitry QQ302 and at least a portion of memory 304 may be considered to be integrated.

Communication interface QQ306 is used in the wired or wireless communication of signaling and/or data between network node QQ300 and one or more other network nodes and/or UEs QQ110. As illustrated, communication interface QQ306 comprises port(s)/terminal(s) QQ316 to send and receive data, for example to and from network QQ102 over a wired connection. Interface QQ306 also includes radio front end circuitry QQ318 that may be coupled to, or in certain embodiments be a part of, antenna QQ310. Radio front end circuitry QQ318 comprises filters QQ320 and amplifiers QQ322. Radio front end circuitry QQ318 may be connected to antenna QQ310 and processing circuitry QQ302. Radio front end circuitry QQ318 may be configured to condition signals communicated between antenna QQ310 and processing circuitry QQ302. Radio front end circuitry QQ318 may receive digital data that is to be sent out to other network nodes or WDs via a wireless connection. Radio front end circuitry QQ318 may convert the digital data into a radio signal having the appropriate channel and bandwidth parameters using a combination of filters QQ320 and/or amplifiers QQ322. The radio signal may then be transmitted via antenna QQ310. Similarly, when receiving data, antenna QQ310 may collect radio signals which are then converted into digital data by radio front end circuitry QQ318. The digital data may be passed to processing circuitry QQ302. In other embodiments, the interface may comprise different components and/or different combinations of components.

In certain alternative embodiments, network node QQ300 may not include separate radio front end circuitry QQ318. Instead, processing circuitry QQ302 may comprise radio front end circuitry QQ318 and may be connected to antenna QQ310 without separate radio front end circuitry QQ318. Similarly, in some embodiments, all or some of RF transceiver circuitry QQ312 may be considered a part of interface QQ306. In still other embodiments, interface QQ306 may include one or more ports or terminals QQ316, radio front end circuitry QQ318, and RF transceiver circuitry QQ312, as part of a radio unit (not shown), and interface QQ306 may communicate with baseband processing circuitry QQ314, which is part of a digital unit (not shown).

Antenna QQ310 may include one or more antennas, or antenna arrays, configured to send and/or receive wireless signals. Antenna QQ310 may be coupled to radio front end circuitry QQ318 and may be any type of antenna capable of transmitting and receiving data and/or signals wirelessly. In some embodiments, antenna QQ310 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ310 may be separate from network node QQ300 and may be connectable to network node QQ300 through an interface or port.

Antenna QQ310, interface QQ306, and/or processing circuitry QQ302 may be configured to perform any receiving operations and/or certain obtaining operations described herein as being performed by a network node. Any information, data and/or signals may be received from a wireless device, another network node and/or any other network equipment. Similarly, antenna QQ310, interface QQ306, and/or processing circuitry QQ302 may be configured to perform any transmitting operations described herein as being performed by a network node. Any information, data and/or signals may be transmitted to a wireless device, another network node and/or any other network equipment.

Power source QQ308 may be configured to provide power to the various components of network node QQ300 in a form suitable for the respective components (e.g., at a voltage and current level needed for each respective component). Power source QQ308 may either be included in, or external to, network node QQ300. For example, network node QQ300 may be connectable to an external power source (e.g., an electricity outlet) via an input circuitry or interface such as an electrical cable. As a further example, power source QQ308 may comprise a source of power in the form of a battery or battery pack. The battery may provide backup power should the external power source fail. Other types of power sources, such as photovoltaic devices, may also be used.

Alternative embodiments of network node QQ300 may include additional components beyond those shown in FIG. QQ3 that may be responsible for providing certain aspects of the network node's functionality, including any of the functionality described herein and/or any functionality necessary to support the subject matter described herein. For example, network node QQ300 may include user interface equipment to allow input of information into network node QQ300 and to allow output of information from network node QQ300. This may allow a user to perform diagnostic, maintenance, repair, and other administrative functions for network node QQ300.

FIG. QQ4 is a block diagram of a host QQ400, according to an example embodiment. The host QQ400, which may be a computer operative as a server, includes processing circuitry QQ402 coupled via a bus QQ404 to an input/output interface QQ406 and a network interface QQ408. The host QQ400 further includes a power source QQ410 and memory QQ412, which comprises one or more types of storage elements—i.e., one or more types of computer-readable medium. The memory QQ412 stores one or more host application programs QQ414 and data QQ416, according to which the host QQ400 operates as described herein, e.g., the host QQ400 provides user data to or receives user data from a UE QQ 112, based on communicating with the UE QQ212 through a telecommunication network QQ102.

FIG. QQ5 is a schematic block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments QQ500 hosted by one or more of hardware nodes QQ504. Further, in embodiments in which the virtual node is not a radio access node or does not require radio connectivity (e.g., a core network node), then the network node may be entirely virtualized.

The functions may be implemented by one or more applications QQ502 (which may alternatively be called software instances, virtual appliances, network functions, virtual nodes, virtual network functions, etc.) operative to implement some of the features, functions, and/or benefits of some of the embodiments disclosed herein. Applications QQ502 are run in virtualization environment QQ500 which provides hardware QQ504 comprising processing circuitry and memory. The memory contains instructions executable by the processing circuitry whereby application(s) QQ502 is/are operative to provide one or more of the features, benefits, and/or functions disclosed herein.

Virtualization environment QQ500, comprises general-purpose or special-purpose network hardware QQ504 comprising a set of one or more processors or processing circuitry, which may be commercial off-the-shelf (COTS) processors, dedicated Application Specific Integrated Circuits (ASICs), or any other type of processing circuitry including digital or analog hardware components or special purpose processors. Each hardware device may comprise memory, which may be non-persistent memory for temporarily storing instructions or software executed by processing circuitry. Each hardware device may comprise one or more network interface controllers (NICs), also known as network interface cards, which include physical network interface. Each hardware device may also include non-transitory, persistent, machine-readable storage media having stored therein software and/or instructions executable by processing circuitry. Software may include any type of software including software for instantiating one or more virtualization layers QQ506 (also referred to as hypervisors), software to execute virtual machines, virtual machines or VMs QQ508 (QQ508A and QQ508B are shown as examples), as well as software allowing it to execute functions, features and/or benefits described in relation with some embodiments described herein.

Virtual machines QQ508, comprise virtual processing, virtual memory, virtual networking or interface and virtual storage, and may be run by a corresponding virtualization layer QQ506 or hypervisor. Different embodiments of the instance of virtual appliance QQ502 may be implemented on one or more of virtual machines QQ508, and the implementations may be made in different ways.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine(s) QQ508 may be a software implementation of a physical machine that runs programs as if they were executing on a physical, non-virtualized machine. Each of virtual machines QQ508, and that part of hardware QQ504 that executes that virtual machine, be it hardware dedicated to that virtual machine and/or hardware shared by that virtual machine with others of the virtual machines QQ508, forms a separate virtual network element (VNE). Overall virtualization operations may be controlled by a management and orchestration function QQ510 and a control system QQ512.

FIG. QQ6 is a flowchart illustrating communications between a host QQ602, a network node QQ604 and a UE QQ606. The host QQ602 provides user data at step QQ608 and initiates a transmission carrying the user data to the UE at step QQ610. A connection QQ660 supports communication between the host QQ602 and the network node QQ604. In this context, the host 602 may be a server external to the telecommunication network 102 seen in FIG. QQ1, the network node QQ604 may be a network node QQ110 shown in FIG. 1, and the UE QQ606 may be one of the UEs QQ112 shown in FIG. 1.

At step QQ612, the user data originating from the host QQ602 is received by the network node QQ604 and the network node QQ604 transmits the user data to the UE QQ606. The UE QQ606 receives the user data at step QQ614 and a wireless connection QQ670 supports communication between the UE QQ606 and the network node QQ604.

At step QQ616 the UE QQ606 provides user data for the host QQ602. The UE QQ606 initiates transmission of the user data towards the host QQ602, as shown at step QQ618. At step QQ620, the network node QQ604 receives the user data sent from the UE QQ606 for the host QQ602 and it transmits that user data towards the host QQ602. At step QQ622, the host QQ602 receives the user data. Transfer of user data between the host QQ602 and the UE QQ606 may be understood as being conveyed on an Over-the-Top (OTT) connection QQ650.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

### Abbreviations

At least some of the following abbreviations may be used in this disclosure. If there is an inconsistency between abbreviations, preference should be given to how it is used above. If listed multiple times below, the first listing should be preferred over any subsequent listing(s).
RS Resource Specification
CFSS Customer facing service specification; see [10]
RFSS Resource facing service specification; see [10]
CFS Customer facing service; see [10]
RFS Resource facing service; see [10]
SLA Service Level Agreement; see [2]
SLO Service level objective
SL Service Level
KQI Key quality indicator
KPI Key performance indicator
5QI 5G QoS identifier, see [5]
QoS Quality of Service
NSSAI Network slice selection assistance information, see [5]
S-NSSAI Single network slice selection assistance information, see [5]
SUPI Subscription Permanent identifier
1×RTT CDMA2000 1× Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICHEc/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Power Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1-42. (canceled)

43. A method performed by a computer system associated with a production domain, the method comprising:
receiving items of performance data comprising Key Performance Indicator (KPI) events for one or more types of measured performance of a production domain; and
with respect to a Service Level Agreement (SLA) governing a corresponding service provided by the production domain:
calculating values for one or more Key Quality Indicators (KQIs) with respect to a compliance period defined for the SLA, based on related items of performance data from among the received items of performance data;
identifying nonconformance of the provided service with the SLA for the compliance period, based on evaluating the calculated values of the one or more KQIs with respect to corresponding quality targets defined by Service Level Objectives (SLOs) of the SLA;
generating nonconformance information according to any identified nonconformance; and
outputting the nonconformance information to one or more business control systems associated with the production domain.

44. The method of claim 43, wherein the method comprises receiving the items of performance data as batched data and using timestamp information in the items of performance data to identify particular items of performance data that correspond to the compliance period.

45. The method of claim 43, wherein the method comprises receiving the items of performance data in real-time or near-real-time during the compliance period.

46. The method of claim 43, wherein the method comprises receiving the items of performance data from a Service Assurance System (SAS) of the production domain.

47. The method of claim 43, wherein the items of performance data comprise indications of KPI violations and corresponding clearances of such violations, or comprise performance measurements for use by the computer system in comparing the performance measurements against defined performance thresholds for determining KPI violations and corresponding clearances of such violations.

48. The method of claim 43, wherein the related items of performance data indicate threshold violations or clearances of Key Performance Indicator (KPI) targets monitored for the production domain, or are KPI measurements made on regular, recurring bases for the production domain.

49. The method of claim 48, wherein calculating the values for the one or more KQIs comprises aggregating instances or times of KPI violations for the KPIs represented by the related items of performance data and calculating the one or more KQIs in dependence on the aggregations.

50. The method of claim 43, wherein the nonconformance information indicates particular points of nonconformance with respect to the SLOs.

51. The method of claim 43, wherein the nonconformance information indicates any one or more of a monetary amount to be refunded to a customer associated with the SLA, a service credit to be awarded to the customer, or weights or priority indications to be used by a Service Assurance System (SAS) in making future resource management decisions for the production domain with respect to providing the service.

52. The method of claim 43, wherein the one or more business or control systems associated with the production domain comprise a Business Support System (BSS) associated with charging and billing the service associated with the SLA, and wherein the nonconformance information expresses the cost of the detected nonconformance in terms of monetary or service-usage credit or penalty.

53. The method of claim 43, wherein the one or more business or control systems associated with the production domain comprise a Service Assurance System (SAS) associated with management of resources in the production domain for conformance with the SLA, and wherein the nonconformance information expresses the cost of the detected nonconformance in terms of resource management priorities to be applied by the SAS during one or more compliance periods.

54. The method of claim 43, further comprising identifying the related items of performance data from among the received items of performance data.

55. The method of claim 54, wherein identifying the related items of performance data from among the received items of performance data comprises correlating one or more performance-data identifiers with SLA information associated with the SLA, to determine which items of performance data are related to the provided service.

56. The method of claim 55, wherein the SLA information comprises one or more data structures that link particular values of the one or more identifiers to the SLA, and wherein the method comprises determining whether a particular received item of performance data relates to the SLA, based on indexing into the one or more data structures using values of the one or more identifiers that are associated with the particular received item of performance data.

57. The method of claim 54, wherein the one or more identifiers comprise one or more of: a service identifier, a network slice identifier, a Subscription Permanent Identifier (SUPI), a device or device group identifier, or a 5QI value.

58. The method of claim 43, wherein the provided service is one among a plurality of provided services, each having a corresponding SLA, wherein the received items of performance data carry or are accompanied by one or more identifiers that are linked to one or more of the SLAs, and wherein the method comprises using the one or more identifiers to identify the related items of performance data for each SLA and correspondingly identifying nonconformance of the corresponding service for the compliance period defined for each SLA.

59. The method of claim 43, wherein the production domain is a telecommunication network, and wherein the service governed by the SLA is a networking service provided by a network slice provided via the telecommunication network.

60. The method of claim 43, wherein the telecommunication network is a wireless communication network, such as a wireless communication network configured for operation in accordance with Third Generation Partnership Project (3GPP) technical specifications, and wherein the service governed by the SLA is a communication service provided by or through the telecommunication network.

61. The method of claim 43, wherein:
the production domain is a data center and the service governed by the SLA is a data-center service, or
the production domain is a cloud processing environment and the service governed by the SLA comprises virtualized core network (CN) or virtualized radio access network (RAN) processing.

62. A computer system associated with a production domain, the computer system comprising:
communication interface circuitry; and
processing circuitry operatively associated with the communication interface circuitry and configured to:
receive, via the communication interface circuitry, items of performance data comprising Key Performance Indicator (KPI) events for one or more types of measured performance of a production domain; and
with respect to a Service Level Agreement (SLA) governing a corresponding service provided by the production domain:
calculate values for one or more Key Quality Indicators (KQIs) with respect to a compliance period defined for the SLA, based on related items of performance data from among the received items of performance data;
identify nonconformance of the provided service with the SLA for the compliance period, based on evaluating the calculated values of the one or more KQIs with respect to corresponding quality targets defined by Service Level Objectives (SLOs) of the SLA;
generate nonconformance information according to any identified nonconformance; and
output the nonconformance information to one or more business control systems associated with the production domain.
